(19) United States
(12) Patent Application Publication
(10) Pub. No.: US 2026/0289267 A1
(43) Pub. Date: Sep. 24, 2026

(54) SYSTEM

(71) Applicant: SoftBank Group Corp., Tokyo (JP)

(72) Inventor: Kazuki MATSUMOTO, Tokyo (JP)

(73) Assignee: SoftBank Group Corp., Tokyo (JP)

(21) Appl. No.: 19/565,632

(22) Filed: Mar. 13, 2026

(30) Foreign Application Priority Data
Mar. 19, 2025 (JP) 2025-045095

(51) Int. Cl. G06N 3/0475

(52) U.S. Cl. CPC G06N 3/0475

(57) ABSTRACT

A system includes a processor that is configured to receive and analyze information from a user, evaluate an emotional state of the user by using an emotion analysis unit, and generate a prompt sentence by using a generative AI model and generate a response including psychological consideration.

### CROSS-REFERENCE TO RELATED APPLICATION

This application is based on and claims priority under 35 USC 119 from Japanese Patent Application No. 2025-045095 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional consultation support systems and information routing systems, user input is typically processed in a uniform manner without sufficiently considering the emotional state of the user. As a result, a system may fail to recognize that a user is under significant psychological stress, and may provide responses that are technically correct but lack psychological consideration, thereby reducing user satisfaction and potentially exacerbating the user's distress. Furthermore, conventional systems have difficulty automatically determining appropriate internal or external services or departments based on unstructured user input, which leads to inefficient routing and delays in providing suitable support. In addition, priority handling of information is often based only on the content type or predefined rules and does not adequately reflect the urgency inferred from the user's emotional state. Therefore, there is a need for a system that analyzes user information together with the user's emotional state, generates psychologically considerate responses, automatically determines related services or departments, and sets priorities for information distribution in accordance with the user's emotional state.

### SUMMARY

To solve the above problems, the present invention provides a system comprising a processor, wherein the processor is configured to receive and analyze information from a user, evaluate an emotional state of the user by using an emotion analysis unit, and generate a prompt sentence by using a generative AI model and generate a response including psychological consideration. The processor is further configured to generate a prompt sentence that automatically determines, based on content of the information, a related service or department, thereby enabling appropriate routing of the information without requiring manual classification by an operator. In addition, the processor is configured to set a priority of the information based on the emotional state of the user and to distribute the information to an appropriate service or department, so that information associated with a highly stressed or emotionally burdened user can be processed preferentially. By combining emotion analysis, generative AI-based prompt generation, automatic determination of related services or departments, and priority control based on the emotional state, the system can provide responses with psychological consideration and can efficiently route and handle user information in accordance with both the content and the emotional context.

The term “system” refers to an integrated combination of hardware and software components configured to execute the processing steps described in the claims, including at least one processor and any associated memory, storage, and communication interfaces.

The term “processor” refers to any hardware circuitry or combination of hardware and software, such as a central processing unit (CPU), graphics processing unit (GPU), digital signal processor (DSP), microcontroller, application-specific integrated circuit (ASIC), or field-programmable gate array (FPGA), that is capable of executing instructions to perform the claimed processing.

The term “user” refers to any human or entity that provides information to the system, receives responses from the system, or otherwise interacts with the system through an input/output interface.

The term “information” refers to any data, content, or message provided by the user to the system, including but not limited to text, voice, multimedia content, inquiries, complaints, consultation content, or administrative requests, whether structured or unstructured.

The term “receive and analyze information from a user” refers to operations in which the processor acquires user-provided information via an input interface or communication network and performs processing such as parsing, normalization, classification, extraction of features, or other computational analysis on the information.

The term “emotion analysis unit” refers to a functional module, implemented in hardware, software, or a combination thereof, that is configured to process user information and output an estimate of an emotional state of the user, for example by applying rule-based logic, statistical models, or machine-learning models.

The term “emotional state” refers to a psychological or affective condition of the user, such as sadness, anxiety, anger, fear, relief, neutrality, or other emotional categories, which is inferred or estimated by the emotion analysis unit from the information provided by the user.

The term “evaluate an emotional state of the user” refers to operations in which the processor, using the emotion analysis unit, determines one or more emotional categories and, optionally, numerical scores, probabilities, or confidence values representing the intensity or likelihood of each emotional category.

The term “generative AI model” refers to an artificial intelligence model, such as a large language model, neural network, or other generative model, that is configured to generate text or other output content in response to input data, including prompts derived from user information.

The term “prompt sentence” refers to a text string or set of text strings generated by the processor and provided as input to the generative AI model, the text string or set of text strings including instructions, contextual information, or constraints that guide the generative AI model in producing a desired response.

The term “generate a prompt sentence by using a generative AI model” refers to operations in which the processor constructs or adjusts a prompt sentence, optionally by utilizing prior outputs, metadata, templates, or model-specific formatting, so that the prompt sentence can be used as input to the generative AI model for subsequent response generation.

The term “response including psychological consideration” refers to a response generated by the processor, at least in part using the generative AI model, that not only addresses the substantive content of the user's information but also reflects the user's emotional state by including empathetic expressions, supportive wording, or other content that takes the user's psychological condition into account.

The term “related service or department” refers to an internal or external organizational unit, function, or contact point, such as a specific administrative office, support desk, customer service group, or specialized consultation service, that is appropriate for handling the content of the user's information.

The term “generate a prompt sentence that automatically determines, based on content of the information, a related service or department” refers to operations in which the processor analyzes the content of the user's information, selects or encodes classification criteria into a prompt sentence, and uses the prompt sentence to cause the generative AI model or another processing component to infer or identify one or more suitable services or departments without manual intervention.

The term “priority of the information” refers to an order, level, or ranking assigned to a piece of user information that indicates a degree of urgency, importance, or processing precedence relative to other pieces of information.

The term “set a priority of the information based on the emotional state of the user” refers to operations in which the processor adjusts or assigns a priority level to the information by using the evaluated emotional state, so that information associated with higher stress, stronger negative emotion, or higher inferred urgency is given higher processing priority than other information.

The term “distribute the information to an appropriate service or department” refers to operations in which the processor routes, forwards, or assigns the user's information, together with any associated priority or metadata, to a selected related service or department via an internal communication mechanism, external network, or interface suitable for enabling that service or department to handle the information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

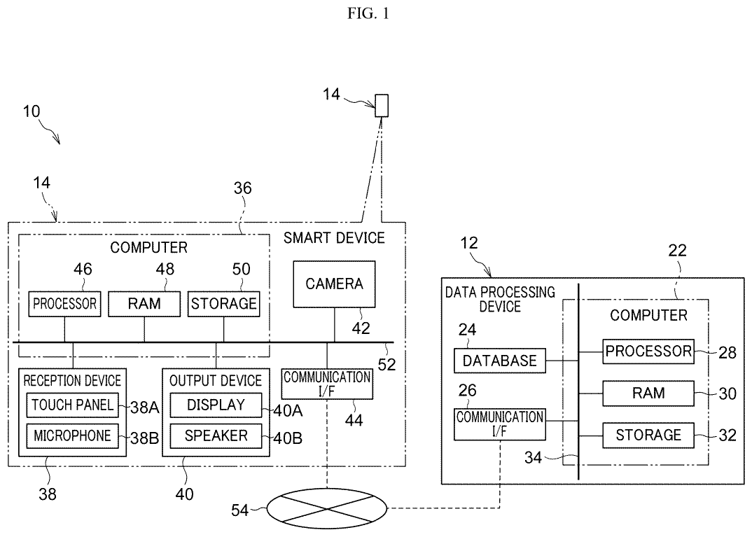

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

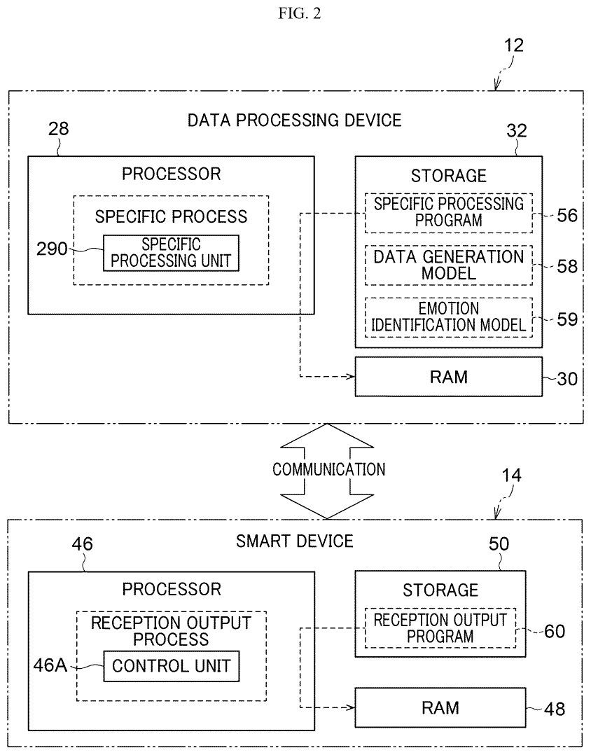

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented consultation systems that use natural language processing and automatic response generation suffer from several technical limitations that degrade the efficiency and reliability of the underlying computing infrastructure. First, such systems typically treat user input text as a flat string and pass it directly to a generative model, without generating structured analysis result data that separates content, intent, and emotionally relevant features. As a result, the computing resources of the generative model are consumed inefficiently, since the model must internally infer information that could have been pre-computed by specialized language analysis processes. This leads to longer processing time, higher compute load, and unstable response quality across different types of consultation requests.

Second, existing systems generally lack a coherent mechanism within the server architecture to combine language analysis, emotion analysis, and external data retrieval into a unified prompt sentence for a generative model. Without such a unified mechanism, the server either omits relevant external information or redundantly queries external systems in an ad hoc manner. This can cause unnecessary network traffic, increased latency, and inconsistent or incomplete responses, which in turn degrades the technical performance of the server-side processing pipeline.

Third, many known systems do not dynamically adjust the level of detail, order of explanation, or response length in accordance with machine-evaluated emotion states of users. Instead, they output static or generic responses that ignore the emotional context inferred from the user's input. From a computer-technology perspective, this means that the server does not use available emotion analysis result data as control information within the response-generation pipeline. Consequently, the system fails to exploit internal control signals that could optimize how the generative model is prompted, thereby limiting the ability of the server to control token generation patterns, reduce unnecessary output, and stabilize response structure.

Fourth, existing multi-modal consultation systems that accept voice and text input often handle audio recognition as a separate siloed process. The voice recognition pipeline typically outputs text that is then treated differently from manually entered text, resulting in duplicated logic paths and additional conversion layers. This increases the complexity of the software stack, makes error handling and logging more difficult, and prevents unified optimization of the language analysis pipeline for both text and voice inputs.

Accordingly, there is a need for an improved computer-implemented system and server architecture that (i) generates structured analysis result data from natural language input, (ii) systematically integrates emotion analysis result data and external information into a machine-constructed prompt sentence, (iii) uses priority information derived from emotion analysis as internal control data for the generative model, and (iv) unifies text and voice inputs into a single language analysis pipeline. By addressing these issues, the invention aims to improve the technical operation of the server-side processing pipeline, reduce computational waste, and stabilize the generation of context-appropriate, psychologically considerate responses, thereby providing a concrete improvement in computer technology rather than merely automating a human mental process.

The specific processing by the specific processing unit 290 of the data processing device 12 in Example 1 is realized by the following means.

The present invention provides a server comprising a processor configured to acquire natural language information from a terminal, perform language analysis processing including structural analysis and phrase extraction on the natural language information to generate analysis result data indicating content and intent of the natural language information, generate emotion analysis result data indicating an emotional state of a user, construct a prompt sentence on the basis of the analysis result data and the emotion analysis result data to define a tone and explanatory content of a response, provide the prompt sentence as an input to a generative artificial intelligence model to cause generation of a response sentence including psychological consideration, perform a query to an external information processing apparatus or an external information storage apparatus via a communication interface on the basis of phrases or identification information extracted from the natural language information, acquire external information and associate the external information with the analysis result data and integrate the external information into at least one of the prompt sentence and the response sentence, receive voice information from the terminal, convert the voice information into character information by performing acoustic analysis and speech recognition processing and supply converted character information as the natural language information to the language analysis processing, and format the response sentence generated by the generative artificial intelligence model as display data and transmit the display data to the terminal for presentation to the user. This enables the server to implement a unified, machine-controlled processing pipeline that pre-computes structured analysis result data, exploits emotion-derived priority information to control prompting of the generative artificial intelligence model, efficiently incorporates external information into responses, and normalizes both text and voice inputs into a single optimized language analysis pathway, thereby reducing computational overhead, improving response consistency, and enhancing the technical performance of the computer system.

The term “natural language information” refers to character information or text data expressed in a human language, such as sentences, phrases, or words, that are input by a user and processed by the system as linguistic content.

The term “user terminal” refers to an electronic device operated by a user, such as a computing device or communication device, that is configured to transmit input information to the server and receive output information from the server.

The term “language analysis processing” refers to a sequence of operations executed by a processor to analyze natural language information, including at least one of structural analysis, tokenization, morphological analysis, syntactic analysis, and phrase extraction.

The term “structural analysis” refers to processing that identifies structural elements of natural language information, including at least one of sentence boundaries, grammatical roles, and syntactic relationships between tokens.

The term “phrase extraction” refers to processing that identifies and extracts meaningful word sequences or linguistic units, such as key phrases, entities, or collocations, from natural language information.

The term “analysis result data” refers to structured data generated by language analysis processing, the structured data indicating at least one of content, intent, topic, or key elements derived from the natural language information.

The term “emotion analysis result data” refers to data obtained by processing natural language information or related input signals to evaluate an emotional state of a user, the data including at least one of emotion category, emotion intensity, sentiment polarity, or anxiety level.

The term “prompt sentence” refers to a machine-constructed text or data structure that is provided as input to a generative artificial intelligence model, the prompt sentence including at least one of instructions, context information, analysis result data, emotion analysis result data, and external information used to control generation of an output by the model.

The term “tone of a response” refers to characteristics of expression style in a response sentence, including at least one of politeness level, empathy level, formality, or directness, as controlled by the prompt sentence.

The term “explanatory content” refers to substantive informational elements included in a response sentence, such as procedural steps, reasons, conditions, or guidance that address a user's inquiry.

The term “generative artificial intelligence model” refers to a trained computational model that generates natural language output by probabilistically predicting sequences of tokens based on input data including a prompt sentence.

The term “response sentence” refers to natural language text generated by the generative artificial intelligence model on the basis of a prompt sentence, the text being intended for presentation to a user as an answer or guidance.

The term “psychological consideration” refers to characteristics of a response sentence that take into account an inferred emotional state of a user, including at least one of empathy, reassurance, mitigation of anxiety, or supportive wording.

The term “external information processing apparatus” refers to a computing system or server, distinct from the server executing the generative model, that processes queries and returns external information via a communication interface.

The term “external information storage apparatus” refers to a storage system or database, external to the server executing the generative model, that stores information accessible via a communication interface in response to queries.

The term “communication interface” refers to a hardware and software combination that enables data exchange between the server and an external apparatus, including at least one of a network interface, communication protocol stack, or application programming interface.

The term “external information” refers to data obtained from an external information processing apparatus or external information storage apparatus, the data including at least one of procedure descriptions, service details, document requirements, or other reference information used to supplement a response sentence.

The term “phrases or identification information” refers to extracted linguistic elements or identifiers derived from natural language information, including at least one of key phrases, entity names, codes, or category labels that are used as parameters for forming queries to external systems.

The term “voice information” refers to analog or digital audio signals representing spoken utterances of a user, captured by an input device and supplied to the server or a recognition component.

The term “acoustic analysis” refers to processing performed on voice information to extract acoustic features, such as spectral characteristics or phonetic patterns, used as intermediate data for speech recognition.

The term “speech recognition processing” refers to computational processing that converts voice information into character information by mapping acoustic features to linguistic units, such as phonemes, words, or sentences.

The term “character information” refers to data represented as sequences of characters in a character set, such as encoded text strings, that correspond to the content of user utterances or system responses.

The term “display data” refers to data formatted for visual presentation on a user terminal, including at least one of text strings, layout information, or metadata controlling how a response sentence is rendered.

The term “business field” refers to a functional domain or category of operations, such as an administrative area, service type, or subject matter, that is relevant to a user's inquiry and may be used to route or tailor a response.

The term “processing entity” refers to an organizational unit, service unit, or logical module responsible for handling a particular category of requests or operations related to a user's inquiry.

The term “attribute information” refers to information indicating at least one of a business field, a processing entity, or another classification label that characterizes a target of an inquiry or a type of processing to be performed.

The term “instruction sentence” refers to a component of a prompt sentence that explicitly directs the generative artificial intelligence model regarding at least one of role, style, target domain, or constraints for generating a response sentence.

The term “priority information” refers to control data indicating at least one of a desired level of detail, an order of explanation, or a target length of a response sentence, the control data being derived from emotion analysis result data.

The term “presentation order” refers to a sequence in which segments of a response sentence or associated information are arranged for output to a user, including ordering of steps, topics, or sections.

In one embodiment, a server cooperates with a terminal operated by a user to implement a computer-implemented consultation system that analyzes natural language information, constructs a prompt sentence, applies a generative AI model, and returns a psychologically considerate response. The server includes at least one processor, a memory, a communication interface, and storage. The terminal includes at least one processor, a memory, a display, an audio input device such as a microphone, and a communication interface. The user operates the terminal to input consultation content in text or voice form.

The server executes an operating system such as a general-purpose server operating system and runs an application program implemented using a server-side framework, for example, a framework based on an interpreted language or a compiled language. The server optionally includes a container runtime and an orchestration framework to deploy multiple instances of the application program. The server is connected via a network to one or more external information processing apparatuses and external information storage apparatuses, which may be implemented as remote servers or database services.

The server stores and executes a natural language processing (NLP) module, an emotion analysis module, a prompt construction module, a generative AI client module, an external information integration module, an audio processing module, and a response formatting module. Each module is realized by executable instructions stored in the memory and executed by the processor.

The terminal executes a client application, such as a web browser or a native application, that provides a user interface to the user. The terminal includes an input component to capture text entered by the user and another input component to capture voice information through the microphone. The terminal transmits user input to the server via the communication interface using a network protocol such as HTTP or HTTPS, and receives display data from the server to render on the display. The terminal optionally includes a text-to-speech engine to convert a response sentence into synthesized audio for playback.

The server uses the NLP module to process natural language information received from the terminal. The server represents natural language information as a token sequence stored in a text buffer structure. The NLP module performs structural analysis and phrase extraction on the token sequence. In one embodiment, the server uses a third-party NLP library or service, such as a cloud-based natural language API or an on-premise library implemented in a high-level language. The NLP module performs tokenization, part-of-speech tagging, dependency parsing, and named entity recognition using statistical models or neural sequence models. The server converts the output of the NLP module into analysis result data, which is stored as a structured record in a relational database or a key-value store. The analysis result data includes fields such as an intent label, a topic label, an array of extracted phrases, and an array of recognized entities.

The server uses the emotion analysis module to generate emotion analysis result data. The emotion analysis module evaluates an emotional state of the user from the natural language information and optionally from interaction history. In one embodiment, the server implements the emotion analysis module as a neural network classifier, such as a recurrent neural network or a transformer-based classifier. The server encodes the tokenized natural language information into numerical feature vectors using a word embedding or sentence embedding model, and inputs the feature vectors into the classifier. The classifier outputs an emotion label (for example, “confused”, “anxious”, “neutral”) and an intensity score. The server stores the emotion analysis result data in association with the analysis result data.

The server uses the prompt construction module to construct a prompt sentence based on the analysis result data and the emotion analysis result data. The prompt construction module operates as a deterministic rule-based component and does not rely solely on a generic template. The server defines prompt segments, such as a role description, a summary of user intent, a representation of extracted phrases and entities, a description of the user's emotional state, and an instruction for response structure. The server concatenates these segments into a prompt sentence or prompt block.

In one concrete example, the user enters the following natural language information at the terminal: “I do not understand the procedures at the city hall, especially how to obtain a certificate of residence.” The server processes this natural language information by the NLP module and the emotion analysis module, and the prompt construction module constructs a prompt sentence such as:
“You are a polite and empathetic administrative consultation assistant. The user is confused about city hall procedures and wants to know how to obtain a certificate of residence. Detected intent: procedure inquiry. Detected emotion: confusion and mild anxiety. Extracted keywords: [city hall, certificate of residence]. External official information: [Step 1: Visit the city hall with valid identification. Step 2: Fill in the certificate of residence application form. Step 3: Pay the fee of 300 yen. Step 4: Receive the certificate at the counter]. Using this information, generate a psychologically considerate, step-by-step explanation that reassures the user and invites them to ask further questions if something is still unclear.”

The server uses the generative AI client module to transmit the constructed prompt sentence to a generative AI model hosted either locally or remotely. In a preferred embodiment, the generative AI model is implemented as a transformer-based neural network with multiple attention layers, feed-forward layers, and layer normalization components. The generative AI model uses subword tokenization to represent text as token IDs and performs autoregressive generation. The server configures model parameters such as temperature, top-k or top-p sampling thresholds, maximum token length, and a stop sequence. The server executes an API call to the generative AI model endpoint and receives output tokens, which are decoded into a response sentence.

The server does not rely on the generative AI model to infer all context purely from raw user input. The server uses the analysis result data and the emotion analysis result data as structured features to control the prompt sentence. This allows the server to constrain the generative AI model's token generation path to a narrower context region in its parameter space, reducing unnecessary exploration during decoding. As a result, the server achieves improved response consistency, reduced variance of output length, and shorter average response time. The server thus improves the technical operation of the generative AI-based subsystem by offloading part of the reasoning process to deterministic pre-processing modules.

The server also uses the external information integration module to query external information processing apparatuses and external information storage apparatuses. The server uses an HTTP client library to send RESTful queries to remote endpoints. The server constructs query parameters based on extracted phrases or identification information, such as recognized entities, codes, or labels stored in the analysis result data. The external systems return structured data, for example, as JSON documents, including procedure steps, required documents, fees, and contact information. The server normalizes this external information into a canonical internal data structure, which is referenced by the prompt construction module. By integrating external information into the prompt sentence or directly into the response sentence, the server increases the factual accuracy of responses and reduces the number of follow-up calls to external systems, thus reducing network traffic and overall latency.

The server uses the audio processing module to handle voice information captured by the terminal. The terminal records the user's speech as digitized audio, encodes the audio in a standard format, and transmits it to the server or directly to a speech recognition service. The server or the speech recognition service performs acoustic analysis and speech recognition processing. In one embodiment, the speech recognition processing is implemented as a neural acoustic model combined with a language model. The acoustic model converts audio frames into phoneme probabilities, and the language model resolves phoneme sequences into word sequences. The speech recognition output is character information representing the user's speech. The server uses the same NLP module and emotion analysis module for both typed text and speech-derived text, thereby unifying the processing pipeline and eliminating redundant code paths. This reduces implementation complexity and improves maintainability and performance tuning, because optimization of the NLP pipeline automatically applies to both modalities.

The server uses the response formatting module to convert the response sentence generated by the generative AI model into display data. The response formatting module inserts markup for headings, bullet points, or numbered steps and may segment the response sentence into logical sections based on analysis result data or external information. The server encapsulates the formatted data in a response object and transmits the response object to the terminal over the network. The terminal renders the response on the display and may invoke a local text-to-speech engine to synthesize spoken playback of the response sentence.

The server uses priority information derived from the emotion analysis result data as an internal control signal. The server computes a priority score for different aspects of the response, such as detail level, explanation order, and target length. The server encodes this priority information as part of the prompt sentence, for example by including explicit instructions such as “provide a concise overview first, then detailed steps” or “use short, reassuring sentences.” This internal control mechanism allows the generative AI model to allocate token budget differently depending on the user's emotional state, which leads to an improvement in computational efficiency: for non-anxious users, the model can generate shorter, more direct responses, while for anxious users it can generate more detailed and supportive explanations. Thus, the server uses emotion-derived signals to control resource usage and output structure, which is a technical improvement beyond merely simulating human empathy.

The server uses a training procedure to construct and refine the emotion analysis module and optional auxiliary models. In one embodiment, the server uses supervised learning with labeled training data that include user utterances and corresponding emotion annotations. The server initializes a neural network with random weights, performs forward propagation on training samples to compute predicted emotion probabilities, and applies a loss function such as cross-entropy between predicted distributions and ground truth labels. The server uses gradient-based optimization, such as stochastic gradient descent or an adaptive optimizer, to update network weights. The server may also perform data augmentation techniques, such as paraphrasing user utterances or adding noise, to improve robustness. By explicitly defining the training process, the server makes the behavior of the emotion analysis module reproducible and tunable as part of the computing infrastructure.

The server can adopt multiple alternative embodiments. In one embodiment, the NLP module, emotion analysis module, and prompt construction module are all implemented on the same physical server. In another embodiment, the NLP module runs on a separate processing node, and the emotion analysis module is deployed as a microservice. The server may store intermediate analysis result data in a document-oriented database instead of a relational database. The generative AI model may be hosted on a remote inference service or locally on a dedicated accelerator, such as a graphics processing unit or a tensor processing unit. The server may also support alternative neural architectures, such as encoder-decoder transformers or hybrid architectures combining convolutional and recurrent layers.

The server uses a specific data structure to coordinate modules. For each user request, the server creates a session object that includes fields for raw natural language information, tokenized representation, analysis result data, emotion analysis result data, external information records, prompt sentence, model parameters, response sentence, and display data.

The server passes a reference to this session object among modules rather than copying data repeatedly. This reduces memory usage and improves cache locality. The server may also employ a message queue to decouple modules, but in all cases the session object is updated in a defined order to ensure determinism. This concrete data structure and data flow design yields a technical effect of improved processing throughput and easier horizontal scaling of the system.

The server improves error handling and logging by attaching diagnostic metadata to the session object, such as module execution times, external API status codes, and token counts. The server uses this metadata to adaptively adjust model parameters, such as reducing maximum output length if the system experiences high load, thereby maintaining service stability. This adaptive behavior is driven by technical metrics, not by business rules, and contributes to improved computer system performance.

The user interacts with the system through the terminal, but the core improvements reside in how the server processes data internally. The server does not merely replace human judgment with a generic AI model; instead, the server introduces a specialized pipeline that decomposes user input into multiple machine-readable components, uses these components to construct a highly controlled prompt sentence, integrates external data via structured queries, and uses emotion-derived control signals to shape model behavior. This combination of modules and data flows enhances calculation efficiency, response stability, and accuracy beyond what a monolithic generative model or a purely human-driven process could achieve.

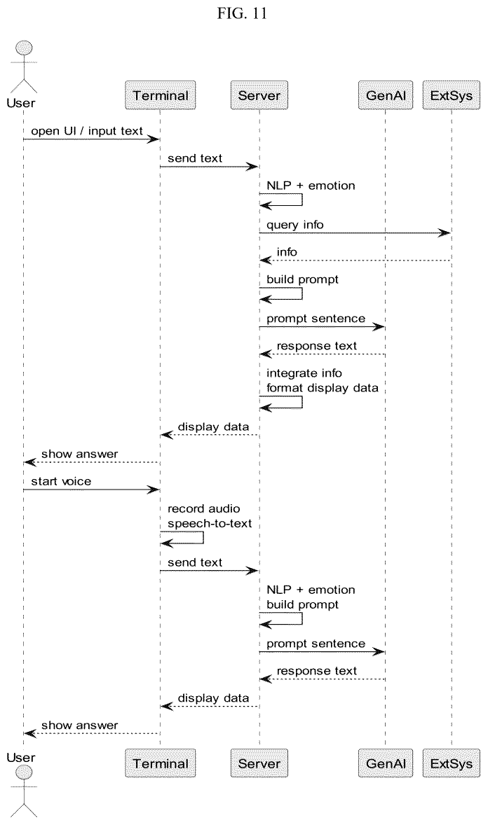

The following describes the processing flow using FIG. 11.

### Step 1:

The user activates a consultation interface on the terminal and selects either text input or voice input.
The terminal receives, as input, a user operation event indicating that the consultation interface should be opened. The terminal processes the event by loading UI components from local storage or from the server via a network request, and the terminal outputs a rendered consultation screen including at least one text input field and at least one control for starting voice recording.

### Step 2:

The user inputs consultation content in text form using the terminal.
The terminal receives, as input, character sequences typed by the user through a keyboard or touch interface. The terminal performs data processing by buffering the keystrokes, validating basic constraints such as maximum length and allowed characters, and assembling the keystrokes into a complete text string. The terminal outputs a structured request object that includes the text string, a user or session identifier, and optional metadata such as language code, and the terminal transmits this object to the server via a communication interface.

### Step 3:

The server receives the text-based consultation request and performs initial validation and logging.
The server receives, as input, the request object containing the user's text and associated metadata from the terminal over a network protocol. The server performs data processing by checking required fields, normalizing character encoding, and removing or escaping potentially harmful sequences such as script tags. The server also computes a hash or identifier for the text and records a log entry in a logging subsystem. The server outputs a sanitized text string and a normalized request record, which are passed to subsequent modules.

### Step 4:

The server performs language analysis processing on the sanitized text to generate analysis result data.
The server receives, as input, the sanitized text string and the normalized request record. The server executes a natural language processing module that tokenizes the text, assigns part-of-speech tags, performs dependency parsing, and applies phrase extraction and named entity recognition. This processing converts the raw text into structured linguistic units and semantic labels. The server outputs analysis result data comprising an intent label, topic label, arrays of extracted phrases and entities, and syntactic relationships, and the server stores this data in association with the request record.

### Step 5:

The server performs emotion analysis on the text to generate emotion analysis result data.
The server receives, as input, the tokenized representation of the text and optionally the analysis result data. The server encodes the tokens into numerical feature vectors using an embedding function, and the server inputs these feature vectors into an emotion classification model. The server performs data computation by executing forward propagation through a neural network to calculate emotion probabilities and intensity scores. The server outputs emotion analysis result data including at least one emotion label and a corresponding confidence or intensity value, and the server associates this data with the request record.

### Step 6:

The server determines attribute information and priority information based on the analysis result data and the emotion analysis result data.
The server receives, as input, the analysis result data and the emotion analysis result data. The server executes a rule-based or model-based decision module that maps intent labels, topic labels, and emotion labels to attribute information such as business fields and processing entities. The server also computes priority information indicating desired response length, level of detail, and explanation order by applying a predetermined mapping table or learned function to the emotion intensity values. The server outputs attribute information and priority information as structured control data for subsequent prompt construction.

### Step 7:

The server queries external information processing apparatuses or external information storage apparatuses to obtain external information related to the consultation.
The server receives, as input, extracted phrases, recognized entities, and attribute information. The server constructs one or more query messages by mapping phrases and entities to query parameters such as category codes, location identifiers, or document types. The server sends these queries through a communication interface to external systems and waits for responses. The external systems return structured data such as procedure steps, required documents, and fees. The server performs data processing by parsing the responses, normalizing field names, and filtering out irrelevant entries. The server outputs external information objects that are linked to the request record.

### Step 8:

The server constructs a prompt sentence for a generative AI model using internal analysis results and external information.
The server receives, as input, the analysis result data, the emotion analysis result data, the attribute information, the priority information, and the external information objects. The server performs data processing by selecting relevant fields, converting structured data into natural language segments, and concatenating these segments according to a predefined layout. The server incorporates role instructions, user intent summaries, emotion descriptions, external procedure details, and priority-based constraints into a single prompt sentence. The server outputs the constructed prompt sentence and associated generation parameters such as maximum token length and temperature.

### Step 9:

The server transmits the prompt sentence to a generative AI model and receives a response sentence.
The server receives, as input, the prompt sentence and the generation parameters. The server encodes the prompt sentence into tokens and sends a model request through a generative AI client interface to a generative AI model endpoint. The generative AI model performs internal neural computations to generate an output token sequence. The server receives the generated token sequence as a response, decodes the tokens into a response sentence, and optionally applies post-processing such as removal of forbidden phrases or trimming to a maximum length. The server outputs a cleaned response sentence associated with the request record.

### Step 10:

The server integrates external information into the response sentence and prepares display data.
The server receives, as input, the cleaned response sentence and the external information objects. The server performs data processing by comparing key concepts in the response sentence with the external information, inserting or adjusting factual details such as step numbers, document names, and fee amounts where appropriate. The server also segments the response into logical sections and applies formatting rules based on priority information to control the order and emphasis of each section. The server outputs display data structures that include the final response text and layout metadata.

### Step 11:

The server transmits the display data to the terminal for presentation to the user.
The server receives, as input, the display data structures and the terminal identifier from the request record. The server serializes the display data into a response message, attaches necessary headers, and sends the message over the network via the communication interface.
The server outputs a network response that reaches the terminal and marks the request record as completed.

### Step 12:

The terminal receives the display data and renders the response to the user.
The terminal receives, as input, the network response containing the display data. The terminal performs data processing by parsing the response, extracting the response text and layout metadata, and updating the user interface. The terminal renders the response sentence in a text area, applies formatting such as bullet points or numbered steps, and adjusts scrolling so that the new content is visible. The terminal outputs a visual representation of the response on the display and optionally generates an audio output if a text-to-speech function is enabled.

### Step 13:

The user alternatively provides consultation content in voice form using the terminal.
The terminal receives, as input, a user operation to start voice recording. The terminal activates the microphone, samples the analog audio signal, converts it into digital audio frames, and buffers the frames in memory. The terminal outputs a digitized audio stream representing the user's speech.

### Step 14:

The terminal converts the digitized audio stream into text and sends the resulting text to the server.
The terminal receives, as input, the buffered audio stream. The terminal sends the audio stream to a speech recognition module, which may reside locally or on an external service.
The speech recognition module performs acoustic analysis and speech recognition, converting audio frames into phonetic features and then into character sequences. The terminal receives recognized text as output from the speech recognition module. The terminal then validates the recognized text and packages it into a request object analogous to the text-input case. The terminal outputs this request object and transmits it to the server, after which the server repeats Steps 3 through 12 using the speech-derived text as natural language information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional consultation support systems, including administrative and security-related help desks, computer processing is typically limited to simple keyword matching, static rule engines, or template-based responses. Such systems suffer from several technical deficiencies.

First, conventional systems are not architected to reliably process heterogeneous input modalities, such as audio and text, in an integrated pipeline. Audio input is often treated as an external pre-processing step, and the core system operates only on already-transcribed text.

As a result, context, temporal structure, and metadata associated with the original audio are not consistently propagated through subsequent stages. This leads to information loss and degrades the ability of the system to accurately infer safety-related concerns or psychological states from the user's input.

Second, natural language processing components in existing systems are generally used in isolation, without systematically coupling their outputs to downstream prompt construction for generative artificial intelligence models. In many cases, a generative model is given only the raw user text, without a structured representation of safety-related terms, emotional indicators, or contextual attributes. This results in unstable response behavior, inconsistent quality of psychologically considerate responses, and difficulty in controlling or auditing the behavior of the generative model.

Third, there is no integrated, machine-implemented mechanism for dynamically tying the output of natural language analysis and generative response generation to automated, programmatic interaction with external information processing apparatuses, such as systems operated by different organizations. Existing systems typically require human operators to manually read the user's message, judge the risk or urgency, and then decide whether to forward information to external systems. This manual step introduces latency, is prone to inconsistency, and does not scale for high-volume or real-time consultation scenarios.

Fourth, prior architectures do not provide a unified computational framework in which risk or urgency evaluation, priority setting, and routing to external systems are algorithmically derived from the same internal representations used to generate psychologically considerate responses. In other words, the path that controls the external integration is often decoupled from the language understanding path, leading to duplicated logic, increased maintenance cost, and opportunities for inconsistent decisions.

From a computer-technology standpoint, these deficiencies manifest as inefficient use of processing resources, increased network overhead due to repeated or redundant calls to external services, and reduced determinism in the system's behavior. It is difficult to verifiably reproduce decisions taken by the system, to log all relevant intermediate artifacts (such as prompt sentences and analysis results), and to enforce consistent policies for risk handling and escalation.

Accordingly, there is a need for an improved computer-implemented system and processing architecture that (i) ingests audio and text consultation content in a unified manner, (ii) performs structured natural language analysis to extract safety-related terms, emotional indicators, and contextual information, (iii) uses such structured analysis to construct prompt sentences for a generative artificial intelligence model in a controlled and auditable way, and (iv) evaluates the risk or urgency of the consultation content to automatically and programmatically cooperate with external information processing apparatuses through an application programming interface. By addressing these issues, the present invention seeks to improve the functioning of computers themselves in the domain of automated consultation handling, rather than merely automating a human mental process.

The specific processing by the specific processing unit 290 of the data processing device 12 in Application Example 1 is realized by the following means.

The present invention provides a server comprising a processor configured to receive consultation content from a user as audio information or character information, to normalize and store the consultation content as comprehensive feature information associated with session metadata, to convert audio information included in the consultation content into character information by using a speech recognition technique and to generate a consultation text based on a conversion result, to perform natural language processing on the consultation text including morphological analysis, syntactic analysis, and semantic analysis and to extract important terms including terms indicating safety concerns and terms indicating a psychological state, as well as contextual information, to construct a prompt sentence based on the consultation text, the important terms, and the contextual information, the prompt sentence including conditions for generation of a psychologically considerate response and conditions for cooperation with an external organization or an external division, to input the prompt sentence into a generative artificial intelligence model and to cause the generative artificial intelligence model to generate a response text including psychological consideration, to transmit the response text to a user terminal, and to evaluate a risk level or an urgency level of the consultation content based on the important terms and the contextual information and, in accordance with an evaluation result, to transmit the consultation content or summary information thereof to an external information processing apparatus via an application programming interface. This enables a unified, machine-implemented processing pipeline in which heterogeneous user inputs are automatically converted into structured representations, used to deterministically construct prompt sentences for a generative artificial intelligence model, and further used to algorithmically evaluate risk and urgency so that the server can both generate stable psychologically considerate responses and execute consistent, low-latency routing and cooperation with external information processing apparatuses, thereby improving the overall performance, control, and reliability of computer-implemented consultation handling.

The term “consultation content” refers to information representing an inquiry, concern, or request for support provided by a user, including but not limited to natural language expressions about safety, administration, or personal matters, and encompassing both audio information and character information.

The term “audio information” refers to data representing sound signals, including a user's speech captured by an input device such as a microphone, and encoded in a digital audio format suitable for processing by a computer system.

The term “character information” refers to data representing textual content encoded as characters or strings in a digital format, including text directly input by a user or text obtained by converting audio information into written form.

The term “comprehensive feature information” refers to structured data generated from the consultation content, including the original text, metadata, extracted tokens, semantic attributes, and other features that collectively describe the content and context of the consultation in a machine-processable form.

The term “speech recognition technique” refers to a computational method or algorithm that analyzes audio information and produces a corresponding sequence of characters or words, thereby converting spoken language into text that can be processed by a computer.

The term “conversion result” refers to the textual output generated by the speech recognition technique from the audio information, including any recognized words, phrases, or sentences used as input for subsequent processing.

The term “consultation text” refers to a text representation of the consultation content, including character information directly input by the user and character information obtained as the conversion result of audio information, and serving as the basis for natural language processing.

The term “natural language processing” refers to a category of computational techniques for analyzing and understanding human language, including operations such as tokenization, part-of-speech tagging, syntactic parsing, semantic interpretation, and entity recognition.

The term “morphological analysis” refers to a processing operation that segments text into constituent units such as words or morphemes and identifies their grammatical categories or inflectional forms.

The term “syntactic analysis” refers to a processing operation that determines structural relationships among words or phrases in the consultation text, such as dependencies or phrase structures, in order to represent the grammatical structure of a sentence.

The term “semantic analysis” refers to a processing operation that infers meaning from the consultation text, including the identification of roles, relationships, topics, and implied intentions, in order to create a representation of the content's semantics.

The term “important terms” refers to words, phrases, or expressions extracted from the consultation text that have significance for determining a user's concern, safety-related issues, emotional state, or contextual attributes relevant to subsequent processing.

The term “terms indicating safety concerns” refers to a subset of important terms that describe or imply potential risk, danger, criminal activity, or threats to personal or public safety within the consultation content.

The term “terms indicating a psychological state” refers to a subset of important terms that describe or imply the emotional or mental condition of the user, including expressions of anxiety, fear, distress, or other affective states.

The term “contextual information” refers to data describing circumstances surrounding the consultation content, including but not limited to location type, time information, repetition patterns, entities involved, and other attributes that influence interpretation of risk, urgency, or appropriate responses.

The term “prompt sentence” refers to a text sequence constructed for input to a generative artificial intelligence model, the text sequence including the consultation text and structured information such as important terms, contextual information, and explicit instructions that condition the behavior of the generative artificial intelligence model.

The term “psychologically considerate response” refers to a response text that is generated under conditions specified in the prompt sentence and that is designed to acknowledge and address the user's emotional or psychological state in a supportive, empathetic, and non-harmful manner.

The term “generative artificial intelligence model” refers to a computational model that receives a prompt sentence as input and probabilistically generates new text or other content, the model being trained on data representing natural language in order to produce coherent and contextually appropriate responses.

The term “external organization” refers to an entity distinct from the operator of the server, including but not limited to a public agency, a security provider, or another institution that may receive information related to the consultation content.

The term “external division” refers to a subunit or department within an organization, internal or external, that is responsible for handling certain types of consultation content, such as a specific service, office, or functional unit.

The term “response text” refers to a text output generated by the generative artificial intelligence model in accordance with the prompt sentence, the text output being suitable for presentation to the user as an answer or guidance.

The term “user terminal” refers to an information processing apparatus operated by a user, such as a smartphone, tablet, personal computer, or other communication device, that provides an interface for sending consultation content to the server and receiving the response text.

The term “risk level” refers to a classification value indicating the degree of potential harm, danger, or negative outcome implied by the consultation content, the classification being derived from analysis of important terms and contextual information.

The term “urgency level” refers to a classification value indicating the time sensitivity or immediacy of action required in response to the consultation content, the classification being derived from analysis of important terms and contextual information.

The term “external information processing apparatus” refers to a computing system managed by an external organization or division that is capable of receiving, storing, and processing consultation-related information transmitted from the server.

The term “application programming interface” refers to a defined set of communication protocols, formats, and procedures that enable programmatic exchange of data between the server and an external information processing apparatus.

The term “business function” refers to a type of operational activity or service performed by an organization, such as safety response, administrative support, counseling, or other functional responsibility related to handling consultation content.

The term “organizational unit” refers to a structural subdivision within an organization, such as a department, section, team, or office, that is assigned specific roles or responsibilities in relation to the consultation content.

The term “priority” refers to an ordering or weighting value assigned to consultation content, indicating the relative importance or processing order based on factors such as risk level, urgency level, and psychological state of the user.

The term “allocation destination” refers to a selected target within an external information processing apparatus, such as a queue, service endpoint, or handler, to which consultation content or associated information is programmatically routed.

In one embodiment, a server, one or more terminals, and a user cooperate to implement the invention.

The server includes one or more processors, a memory, a non-volatile storage device, and a network interface. The server executes an operating system such as a general-purpose server operating system, and executes application software implemented, for example, in a high-level programming language. The memory stores executable program modules including an audio reception module, a speech recognition interface module, a natural language processing module, a prompt construction module, a generative AI interaction module, a risk evaluation module, an external integration module, and a logging and data management module.

The terminal includes input/output hardware such as a microphone, a loudspeaker, a display, a touch panel, and a wireless or wired communication interface. The terminal executes a client application that communicates with the server via a communication network. The terminal captures audio signals using an audio capture framework provided by an operating system of the terminal, such as an application programming interface for microphone input.

The terminal digitizes the captured audio at a predetermined sampling rate and encodes it in a compressed or uncompressed digital audio format. The terminal packages the encoded audio data together with metadata such as a user identifier, a language code, and a timestamp, and transmits the package to the server over a secure network channel.

The user operates the terminal to initiate a consultation session and to provide consultation content in the form of spoken utterances or typed text. The user reads or listens to a response text returned from the server, and optionally continues the consultation based on the response.

The server receives audio information and character information representing consultation content from the terminal through the network interface. The server normalizes and stores the consultation content as comprehensive feature information. For example, the server stores the raw audio file in a file system or object storage, and stores an associated record in a relational or document-oriented database. The record includes fields such as a session identifier, a user identifier, a reference to the audio file, the consultation text, timestamps, a risk level, an urgency level, and references to analysis results and generated prompt sentences.

The server applies a speech recognition technique to audio information included in the consultation content. The server may utilize an external speech recognition service via an application programming interface, or may execute a local speech recognition engine. In either case, the server formats the audio information as a sequence of digital samples and sends them as input features to an acoustic model and a language model. The acoustic model can be implemented as a deep neural network, such as a convolutional neural network or a recurrent neural network, trained on pairs of audio feature sequences and phonetic or subword transcriptions. The language model can be implemented as an n-gram model or a neural sequence model trained on large text corpora. The speech recognition technique computes likelihoods of phoneme or subword sequences from the acoustic features and combines them with language model probabilities to determine the most probable sequence of words. The output of this computation is a conversion result which includes a text transcription and, optionally, confidence scores and alignment information. The server stores the conversion result as consultation text in the database.

The server performs natural language processing on the consultation text. The server loads a natural language processing model, for example an off-the-shelf language analysis library, from the memory into the processor. The server first tokenizes the consultation text into a sequence of tokens, performs morphological analysis to identify word forms and parts of speech, and then performs syntactic analysis to determine dependency relations or phrase structure among the tokens. The server also performs semantic analysis by applying semantic role labeling, named-entity recognition, and sentiment or emotion classification. In one implementation, the server uses a pipeline of neural network models, where a sequence encoder such as a bidirectional recurrent neural network or a transformer encoder maps tokens to contextual vectors, and classification layers assign tags or labels to tokens or to entire sentences.

The server extracts important terms from the consultation text based on the results of the natural language processing. The server identifies terms indicating safety concerns, such as expressions referring to suspicious persons, threats, physical danger, or criminal activities, by matching against a safety lexicon and by using classifier outputs. The server also identifies terms indicating a psychological state, such as words expressing anxiety, fear, distress, or hopelessness, by using sentiment lexicons and learned emotion classifiers. Additionally, the server derives contextual information such as a location type, temporal indicators, repetition patterns, and referenced entities, by parsing the syntactic structure and named entities.

The server constructs a prompt sentence for a generative AI model based on the consultation text, the important terms, and the contextual information. The server uses a specific data structure, for example a template object stored in the memory, which contains fixed instruction phrases and placeholders. The server fills the placeholders with the consultation text and elements of the structured analysis data. By combining the raw user text, the extracted main concern, the emotion, and the location type, the server deterministically constructs an input sequence that conditions the behavior of the generative AI model.

For example, the server constructs a prompt sentence such as:
“You are an administrative consultation assistant.
You must respond with empathy and psychological care.
User consultation: Recently, I saw a suspicious person in my neighborhood and I feel anxious.
Extracted information:
   Main concern: suspicious person
   Emotion: anxiety
   Location type: residential neighborhood
Task: Generate a response that reassures the user, offers psychologically considerate wording, and provides practical and safe actions the user can take.”

In another example, the server constructs a prompt sentence such as:
“User consultation: Recently, I saw a suspicious person in my neighborhood and I feel anxious.

Please use psychologically considerate language and provide concrete, safe actions that the user can take.”

The server then provides the prompt sentence as input to a generative AI model. The generative AI model is implemented, for example, as a neural network having a transformer architecture. The neural network includes multiple layers of self-attention and feed-forward sublayers, with learned weight matrices stored in the memory. The model is trained in advance on large collections of natural language data, using a loss function such as cross-entropy between predicted token distributions and ground truth tokens, and using a weight update algorithm such as stochastic gradient descent with variants such as Adam. During training, the model adjusts its internal parameters to minimize prediction error over training sequences. During inference in the present invention, the server keeps the model parameters fixed and computes, for each token position of the response, probability distributions over candidate tokens conditioned on the prompt sentence and previously generated tokens. The server selects tokens from these distributions using a decoding strategy such as greedy decoding or sampling with temperature control, thereby generating a response text token by token.

The server configures the generative AI model with specific parameters, such as a maximum number of output tokens, a temperature for controlling randomness, and penalties for repetition. The server determines these parameters based on system policies stored in configuration data structures. By doing so, the server constrains the response generation process to remain within predetermined behavioral ranges. The server receives the generated response text from the generative AI model and stores it in association with the corresponding consultation record.

The server evaluates a risk level or an urgency level of the consultation content based on the important terms and the contextual information. The server uses a risk evaluation module that implements a scoring algorithm. In one example, the server assigns numeric weights to specific categories of important terms and context attributes. The server computes a weighted sum, or another aggregation function, to derive a risk score. The server compares the risk score to one or more thresholds stored in the configuration, and maps the result to a discrete risk level such as “low,” “medium,” or “high.” Similarly, the server determines an urgency level based on temporal expressions, imminent danger indicators, and emotional intensity. The use of numeric scoring and explicit thresholds enables reproducible and auditable risk evaluation, which differs from a human operator's intuitive judgment.

When the server determines that the risk level or urgency level satisfies a predetermined condition, the server cooperates with an external information processing apparatus. The server constructs a message including at least part of the consultation text, a summary text, the risk level, and the urgency level, along with optional anonymized identifiers or location information. The server encodes this message in a structured format and transmits it to an external apparatus via an application programming interface using a communication protocol such as Hypertext Transfer Protocol over a secure channel. The external information processing apparatus can correspond to a system operated by an organization responsible for handling security or administrative issues. By transmitting the information programmatically when specific technical conditions are satisfied, the server offloads time-critical and repetitive tasks from human personnel and reduces communication latency.

The terminal receives the response text from the server via the network interface. The terminal decodes the received data and displays the response text on a graphical user interface on the display device. The terminal may optionally execute a text-to-speech engine to convert the response text into synthesized audio signals, which are then output through the loudspeaker. The terminal allows the user to review the response and, if desired, initiate further consultation input.

By implementing a specific data flow architecture that tightly couples speech recognition, natural language processing, structured prompt construction, generative response generation, and risk-based external integration, the server improves the functioning of the computer system itself. The server avoids passing only raw text directly to the generative AI model and instead uses a defined intermediate representation that encodes important terms and contextual information. This structured representation, realized as comprehensive feature information and analysis records in the database, enables the server to reuse the same internal data both for deterministic prompt construction and for algorithmic risk evaluation. Consequently, the server reduces redundant computation and network calls, because analysis results need not be recomputed for separate modules.

In contrast to manual consultation workflows, where a human operator reads the raw text and makes discretionary decisions, the server applies non-conventional processing rules. For example, the server uses domain-specific lexicons, learned classifiers, and numeric scoring functions to evaluate safety concerns, and uses explicit algorithmic thresholds to trigger external integration. This processing is not a mere automation of human reading; instead, it defines a computational procedure that can be precisely reproduced, tuned, and verified. The server's architecture also enables efficient logging and auditing: intermediate artifacts such as token sequences, syntactic trees, emotion scores, risk scores, and prompt sentences are stored in structured form, allowing later reconstruction of the decision path and fine-tuning of models and rules.

The use of a transformer-based generative AI model combined with structured prompt sentences improves both the accuracy and stability of generated responses. Because the prompt sentence explicitly includes extracted important terms and context, the generative model is guided to focus on relevant aspects of the consultation content, leading to fewer irrelevant or unsafe responses. This proactive conditioning reduces the need for repeated calls to the generative AI model and thereby reduces computational and network overhead. The server also becomes capable of systematically enforcing policies through pre- and post-processing steps, such as blocking certain categories of advice or adding mandatory safety instructions when specific terms appear.

From a performance perspective, the server can batch multiple natural language processing tasks and external integration calls. The server organizes incoming consultation content into internal queues and applies asynchronous processing, which leads to increased throughput on multi-core processors. By structuring the data in normalized tables and indexes, the server enables fast retrieval of past consultations for reference or for training and evaluation of updated models. The server may also cache certain analysis results or partial model outputs, thereby reducing computational redundancy when similar or related consultation content is received.

In alternative embodiments, the server may execute the speech recognition and natural language processing modules locally without relying on external services. In such cases, the server loads acoustic and language models, as well as language analysis models, from local storage into the memory, and executes them directly on numerical hardware resources such as central processing units or graphics processing units. The server may further deploy specialized accelerators dedicated to neural network computation to increase processing speed. In another variation, the generative AI model may be partitioned across multiple machines, with the server coordinating distributed inference using a parameter server or model sharding technique.

In yet another embodiment, the terminal may perform a part of the processing, such as local speech recognition, and transmit the consultation text instead of raw audio to the server. The server still performs the natural language processing, prompt sentence construction, generative response generation, and risk evaluation steps. This distribution of functions can reduce network bandwidth usage and latency when terminal devices have sufficient computing resources.

Because the server organizes consultation content, analysis results, prompt sentences, response texts, and risk evaluations into explicit data structures and applies defined numerical and symbolic algorithms, the system as a whole provides improved accuracy in identifying safety-related issues, reduced response time in delivering psychologically considerate responses, and reduced error rate in routing cases to appropriate external information processing apparatuses. The invention therefore implements more than an abstract idea of consultation; it specifies an integrated technical solution that modifies the operation of the computer system by introducing specialized data representations, algorithmic pipelines, and generative AI conditioning mechanisms that could not be achieved by simple manual or rule-only processing.

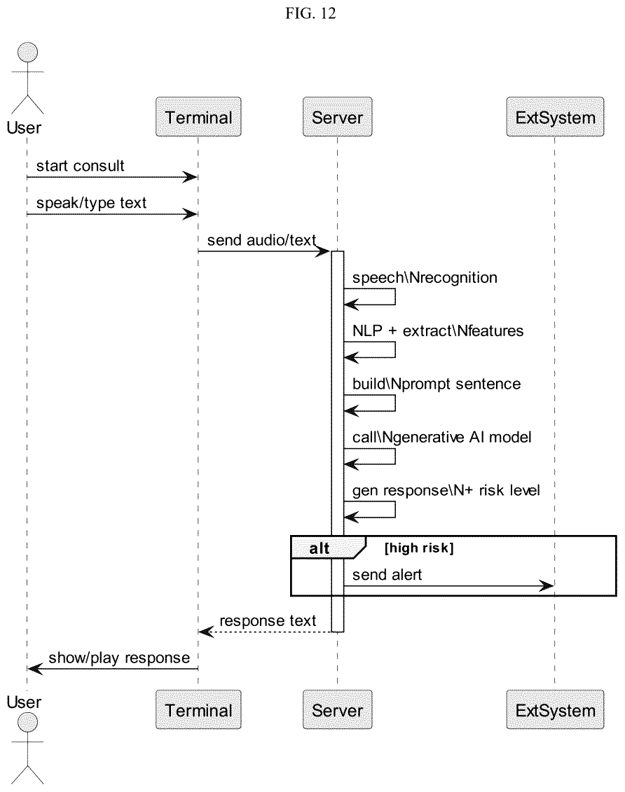

The following describes the processing flow using FIG. 12.

### Step 1:

User operates the terminal to start a consultation session and provide input.
User selects a consultation function on the terminal and speaks a consultation or types a message. The input is, for example, a spoken sentence such as “Recently, I saw a suspicious person in my neighborhood and I feel anxious,” or a text string entered via a keyboard or touch interface. The output of this step is either raw audio data captured by the microphone hardware or a character string stored in the terminal's memory.

### Step 2:

Terminal acquires consultation audio and prepares a transmission packet.
Terminal uses an operating system audio capture interface to sample the user's speech through the microphone at a fixed sampling rate (for example, 16 kHz) and encodes the samples into a digital audio format such as linear PCM or a compressed format. The input of this step is the analog audio signal from the microphone, and the output is an encoded audio buffer. Terminal then creates a data packet containing the encoded audio buffer, a user identifier, a language code, and a timestamp. Terminal performs data formatting operations such as serialization and header attachment to form a structured request object, and transmits this object to the server via a secure communication channel.

### Step 3:

Server receives consultation content and stores comprehensive feature information.
Server accepts the incoming request through a network interface and parses the request to separate the audio payload or text payload, metadata, and protocol headers. The input of this step is the transmitted data packet from the terminal. The server writes the raw audio file into persistent storage and creates a database record including a session identifier, a user identifier, and a reference to the stored audio file or text content. The output of this step is a normalized internal representation of the consultation content, stored as comprehensive feature information in database tables or documents.

### Step 4:

Server performs speech recognition to generate consultation text.
Server reads the stored audio file associated with the current session and sends the audio data as input to a speech recognition engine or to an external speech recognition service. The input of this step is the digital audio stream, and the output is a conversion result containing a recognized text string and optional confidence scores. Server applies acoustic and language modeling algorithms that compute probability distributions over possible symbol sequences and select the most probable transcription. Server then stores the recognized text as consultation text in the database, linked to the session identifier.

### Step 5:

Server executes natural language processing on the consultation text.
Server retrieves the consultation text from the database and inputs the text into a natural language processing module. The input of this step is the character string of the consultation text. The server performs tokenization to split the string into tokens, morphological analysis to assign part-of-speech tags, syntactic analysis to construct dependency or phrase structures, and semantic analysis to derive meaning representations. The data processing here includes mapping tokens to vector representations and applying learned models to compute labels and relationships. The output of this step is a structured analysis object containing tokens, part-of-speech tags, syntactic relations, semantic roles, detected entities, and sentiment or emotion scores.

### Step 6:

Server extracts important terms and contextual information.
Server processes the structured analysis object to identify important terms and context attributes. The input of this step is the set of tokens, tags, and semantic labels from the natural language processing module. Server applies rule-based filters and classifier outputs to detect terms indicating safety concerns and terms indicating a psychological state, and computes context attributes such as location type and temporal expressions. The data processing includes matching tokens against domain lexicons, evaluating classifier probabilities, and aggregating related terms into higher-level concepts. The output of this step is an extracted feature set that includes important terms, safety-related indicators, emotion descriptors, and contextual information stored as an internal data structure.

### Step 7:

Server constructs a prompt sentence for the generative AI model.
Server retrieves the consultation text and the extracted feature set, and loads a prompt template from memory. The input of this step is the user text and the structured feature data. Server performs string substitution and concatenation operations to insert values such as the main concern, emotion, and location type into fixed instruction phrases. For example, server generates a prompt sentence such as:
“You are an administrative consultation assistant.
You must respond with empathy and psychological care.
User consultation: Recently, I saw a suspicious person in my neighborhood and I feel anxious.
Extracted information:
   Main Concern: Suspicious Person
   Emotion: anxiety
   Location type: residential neighborhood
Task: Generate a response that reassures the user, offers psychologically considerate wording, and provides practical and safe actions the user can take.”
The output of this step is a complete prompt sentence string ready for input to the generative AI model.

### Step 8:

Server inputs the prompt sentence into the generative AI model and generates response text.
Server passes the prompt sentence to a generative AI model implemented as a neural network, for example a transformer-based language model. The input of this step is the prompt sentence string. The server converts the text into token identifiers, feeds them through model layers performing attention and feed-forward computations, and iteratively predicts output token probabilities. The server samples or selects tokens based on the probability distributions until a termination condition is met. The data processing includes matrix multiplications, non-linear activations, and softmax operations to produce a coherent response. The output of this step is a response text consisting of a sequence of generated tokens reconstructed into a character string.

### Step 9:

Server evaluates risk level and urgency level based on extracted features.
Server takes the important terms and contextual information as input, along with optional emotion scores from the natural language processing step. The input of this step is the extracted feature set and analysis metrics. Server computes a numeric risk score by applying a weighting function to features such as presence of threat terms, repetition of incidents, and severity indicators, and computes an urgency score based on temporal markers and intensity of emotional expressions. Server compares these scores against predefined thresholds stored in configuration data to assign discrete risk and urgency levels. The output of this step is an annotated record containing the risk level, urgency level, and raw scores associated with the session.

### Step 10:

Server determines external integration and prepares a message for an external information processing apparatus.
Server uses the risk and urgency levels as input to decision logic that determines whether to cooperate with an external information processing apparatus. The input of this step is the annotated record produced in the previous step. If a condition such as a high risk level is satisfied, server constructs a structured message containing a summary of the consultation content, the risk level, and relevant context. The server performs data aggregation and formatting to combine text segments and numeric values into a single message body. The output of this step is an integration message object ready for transmission through an application programming interface.

### Step 11:

Server transmits the response text to the terminal and optionally sends information to an external apparatus.
Server composes a response payload for the terminal using the generated response text and associated metadata, and also uses the integration message if external forwarding is required. The input of this step is the response text string and, when applicable, the integration message object. Server serializes the response data into a network message format and sends it to the terminal via the network interface. If an external apparatus is designated, server similarly serializes and transmits the integration message through the appropriate application programming interface. The output of this step is a delivered response payload at the terminal and, when applicable, a delivered alert or summary at the external information processing apparatus.

### Step 12:

Terminal presents the response to the user.
Terminal receives the response payload from the server and parses the data to extract the response text and any additional information such as risk indicators or recommended actions. The input of this step is the serialized network response from the server. Terminal updates its user interface by rendering the response text in a display area and, if configured, invokes a text-to-speech engine to synthesize speech from the text. The terminal thus converts the digital text into either visual pixels on the display or audio samples played through the loudspeaker. The output of this step is the presented response that the user can read or hear.

### Step 13:

User reviews the response and optionally continues the consultation.
User observes the displayed response or listens to the synthesized audio output on the terminal. The input of this step is the presented response content. Based on the information and guidance received, user decides whether to end the consultation or to provide follow-up questions or clarifications. If user continues, user again supplies audio or text input through the terminal, which becomes new consultation content for another iteration. The output of this step is either termination of the session or new user input that re-enters the processing pipeline beginning from the initial reception steps.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented consultation systems typically treat user input as neutral text and generate generic responses without structurally incorporating a detected emotional state into downstream processing. In many implementations, emotion detection, if present at all, is performed as an auxiliary overlay that does not technically influence the way a language generation engine is conditioned or how a prompt sentence is formed. As a result, the processing pipeline between speech acquisition, natural language understanding, emotion analysis, and response generation is loosely coupled, and the computational resources of a generative model are not effectively utilized to adapt its behavior to the user's emotional context.

In addition, known systems are often configured so that any natural language processing related to emotion is hard-wired to a specific user interface layer. Emotional information is not encoded in a machine-interpretable manner and is not systematically attached to the internal instructions (prompt sentences) sent to a generative AI model. This separation causes several technical drawbacks: (i) the generative model receives only raw or lightly preprocessed text, which reduces the accuracy and stability of emotionally appropriate responses; (ii) the server must perform repeated, ad-hoc pre- and post-processing around the model, increasing processing latency and computational overhead; and (iii) the system cannot reliably control expression style or advice content at the model level according to the detected emotional state.

Furthermore, conventional architectures often process audio input and emotion analysis in separate subsystems that do not share a unified representation of user state. The audio acquisition, speech recognition, emotion analysis, and prompt construction steps are not integrated as a coordinated sequence executed by a processor according to predefined logic. This fragmented design makes it difficult to guarantee consistent behavior across sessions, to scale processing on a server, and to improve model conditioning using structured emotional data. In particular, the absence of a defined mechanism to encode emotion state into the prompt sentence being supplied to the generative model constitutes a technical bottleneck that limits the controllability and reproducibility of generated responses.

Accordingly, there is a need for a computer-implemented technique that structurally integrates (i) acquisition of audio information, (ii) conversion into character information, (iii) evaluation of a user's emotional state, and (iv) construction of a prompt sentence that explicitly incorporates the evaluated emotional state as machine-interpretable data, and that uses this prompt sentence as a control interface to a generative AI model. Such a technique should improve the internal processing pipeline of a server by reducing ad-hoc processing and by enabling the generative AI model to produce responses whose content and expression format are technically controlled based on the encoded emotional state.

The specific processing by the specific processing unit 290 of the data processing device 12 in Example 2 is realized by the following means.

The present invention provides a server comprising a processor configured to acquire audio information from a user via a user apparatus, convert the audio information into character information, analyze the character information to evaluate an emotional state of the user, generate a prompt sentence including at least a representation of a situation of the user and the evaluated emotional state of the user based on the character information and the emotional state, attach data indicating the emotional state to the prompt sentence as structured control information, input the prompt sentence together with the data indicating the emotional state to a generative information processing model, cause the generative information processing model to generate response information including psychological consideration for the user in accordance with the emotional state, and provide the response information to the user apparatus. This enables an integrated computer-implemented processing pipeline in which the emotional state is encoded and propagated as machine-interpretable control data into the prompt sentence supplied to the generative AI model, thereby technically improving the conditioning, controllability, and stability of model-generated responses while reducing ad-hoc processing and latency in the server.

The term “audio information” refers to digital data representing acoustic signals originating from speech of a user, the data being suitable for processing by an information processing apparatus, such as a server or a user apparatus.

The term “user apparatus” refers to an electronic device operated by a user, the device being configured to capture audio information, transmit data to a server, and present response information to the user, such as a portable terminal, a computing terminal, or a communication terminal.

The term “character information” refers to textual data obtained by converting audio information into a sequence of characters or symbols, the textual data being suitable for natural language processing and emotion analysis by a processor.

The term “emotional state” refers to a psychological condition of a user, such as anxiety, sadness, anger, joy, or neutrality, which is inferred from character information by an emotion analysis process and represented as categorical data, numerical scores, or structured metadata.

The term “prompt sentence” refers to text data generated by a processor, the text data including at least a representation of a situation of a user and an emotional state of the user, and being configured as an instruction or input context to condition a generative information processing model.

The term “generative information processing model” refers to a machine learning model configured to generate text or other data based on an input sequence, including but not limited to a neural network model such as a language model, and being capable of producing response information in accordance with a prompt sentence and associated control data.

The term “response information” refers to information generated by a generative information processing model based on a prompt sentence and optionally emotional state data, the information including at least advice, explanations, or guidance that incorporate psychological consideration for a user.

The term “psychological consideration” refers to content characteristics of response information that reflect an evaluated emotional state of a user, including tone, wording, and advice structure adapted to the user's emotional state in order to provide empathetic or supportive communication.

The term “structured control information” refers to data attached to or associated with a prompt sentence in a machine-interpretable format, such as key-value pairs or tagged metadata, the data indicating at least an emotional state of a user and being used to control behavior of a generative information processing model.

The term “analyze the character information to evaluate an emotional state” refers to a process in which a processor applies a computational method, such as natural language processing or statistical classification, to character information to infer and output data indicating a user's emotional state.

The term “provide the response information to the user apparatus” refers to transmitting, outputting, or otherwise making available response information from a server or processor to a user apparatus, such that the user apparatus can present the response information to a user by display, audio output, or another presentation mode.

In the following embodiments, a server cooperates with a terminal and a user to implement the claimed system. The server comprises at least one processor, a memory, a storage unit, and one or more communication interfaces connected to a network. The terminal comprises at least a processor, a memory, an audio input device such as a microphone, an audio output device such as a speaker, and a display device.

The terminal acquires audio information from the user via the microphone. The terminal samples the audio signal as pulse-code modulated data, for example at 16 kHz and 16-bit resolution, and stores the samples in a buffer in the memory. The terminal optionally encodes the buffered samples using an audio compression algorithm such as FLAC or Ogg Opus executed on the terminal processor. This audio information is transmitted from the terminal to the server over a packet-switched network using a secure transport protocol such as HTTPS over TCP/IP.

The server converts the received audio information into character information. The server uses a speech recognition component implemented as software executed on the server processor. In one embodiment, the server uses a speech recognition library that performs acoustic feature extraction, such as Mel-frequency cepstral coefficient extraction, from the audio information, followed by decoding using an acoustic model and a language model. The acoustic model is implemented as a neural network, and the language model is implemented as an n-gram model or a neural language model. The server outputs a sequence of characters encoded in a text format such as UTF-8 and stores the character information in the memory and in a persistent storage unit such as a relational database.

The server analyzes the character information to evaluate an emotional state of the user. The server uses a natural language processing module that includes a trained classifier model. In one embodiment, the server uses a transformer-based neural network model that has multiple self-attention layers, feed-forward layers, and normalization layers. The server tokenizes the character information into subword units, maps the tokens to integer identifiers, and embeds the identifiers into dense vectors using an embedding matrix stored in the memory. The server feeds the embedded sequence into the transformer encoder and obtains a contextual representation for each token and an aggregated representation for the entire input. The server applies a classification layer, such as a fully connected layer followed by a softmax function, to the aggregated representation to compute probabilities for predefined emotional categories such as anxiety, sadness, anger, joy, and neutrality. The server outputs emotional state data as a structured data object that includes at least a primary emotion label and associated probability values, and stores the emotional state data together with the character information and a session identifier in the database.

The server generates a prompt sentence including a representation of a situation of the user and the evaluated emotional state of the user. The server uses a prompt construction module that operates according to predetermined rules and templates stored in the memory. The server may derive an issue description from the character information by applying a text summarization process. In one embodiment, the server uses a smaller transformer-based sequence-to-sequence model or rule-based extraction of key phrases to generate a concise description of the user's situation. The server then combines the issue description and the primary emotion into a template. For example, the server can generate a prompt sentence such as:
“The user is troubled by tense relationships at the workplace and fears that colleagues dislike them. According to emotion analysis, the user feels anxiety. Provide an appropriate, empathetic, and practical advice.”

The server attaches data indicating the emotional state to the prompt sentence as structured control information. The server represents the emotional state as key-value pairs, for example “primary_emotion=anxiety” and a set of numerical scores. The server stores this structured control information in association with the prompt sentence in the memory. The server uses this structured information to control the operation of a generative AI model.

The server inputs the prompt sentence together with the data indicating the emotional state to a generative information processing model. In one embodiment, the generative AI model is a transformer-based autoregressive language model deployed on a server equipped with a graphics processing unit. The generative AI model comprises an embedding layer, multiple self-attention blocks with multi-head attention, feed-forward sublayers, and an output projection layer that maps hidden states to a vocabulary distribution. The server encodes the prompt sentence as a sequence of token identifiers and adds additional control tokens or feature vectors derived from the emotional state data. For example, the server can prepend a special token representing the primary emotion or can add an emotion embedding vector to the token embeddings. The server then feeds the combined embeddings into the generative AI model and executes the model to generate output tokens step by step, using a decoding algorithm such as greedy decoding, beam search, or nucleus sampling.

The server configures generation parameters such as temperature, top-k, and maximum output length based on the emotional state. For example, when the emotional state indicates anxiety, the server may select parameters that favor longer, more explanatory outputs to improve clarity and support. By injecting emotional state data as structured control information into the generative AI model, the server modifies internal attention distributions and hidden state trajectories, which improves the alignment of the generated response with the user's emotional context. This processing is not merely an automation of human behavior but an adjustment of numerical inference in the model that leverages additional features unavailable in manual processing.

The server causes the generative information processing model to generate response information including psychological consideration for the user in accordance with the emotional state. The server obtains the generated token sequence, decodes it into character information, and normalizes the text. The server may enforce formatting rules, sentence boundaries, and content safety constraints using rule-based filters or an auxiliary classifier. The server stores the final response information in the database associated with the session identifier and the emotional state.

In another embodiment, the server uses a generative AI model implemented as an encoder-decoder architecture. In this case, the server supplies the prompt sentence to the encoder, supplies emotional state features as extra encoder inputs or decoder conditioning vectors, and obtains decoded text that is conditioned both on the situation description and on the emotional state. The server can encode the emotional state as a vector appended to the encoder output or as a bias term in the decoder attention layers. This architectural choice enables fine-grained control at multiple layers of the neural network and can improve the stability and reproducibility of emotionally appropriate responses.

The server provides the response information to the user apparatus. The server formats the response information as a data structure that includes at least the generated text and optionally the emotional state. The server transmits this data structure to the terminal using a network protocol. The terminal receives the response information, stores it in the memory, and presents it to the user on the display. The terminal may also convert the response information into synthesized speech using a text-to-speech engine executed on the terminal or on the server. The terminal outputs the synthesized speech through the speaker. Because the server and terminal exchange structured data including emotional state metadata, the system can manage multiple concurrent sessions with reduced ambiguity and can optimize network payloads by transmitting compact labels and scores rather than redundant free-text explanations.

The server improves computer technology in several ways. First, the server reduces processing latency by integrating audio conversion, emotion analysis, prompt construction, and generative response generation into a coordinated pipeline executed on the same or closely connected processors. The server uses shared in-memory data structures for character information and emotional state data, which removes the need for repeated serialization and deserialization between separate subsystems. Second, the server improves the accuracy and stability of generated responses by injecting emotional state information as explicit features or control tokens into the generative AI model. This structural integration reduces variance in model outputs across sessions with similar inputs, thereby improving predictability of system behavior. Third, the server improves resource utilization by adapting generation parameters and prompt complexity based on the emotional state and the length of the input, which reduces unnecessary token generation and network traffic.

The generative AI model used by the server is trained using supervised learning on training data that includes pairs of prompt sentences and desired response texts, optionally annotated with emotional state labels. During training, the server or an associated training apparatus minimizes an objective function such as cross-entropy loss between predicted token distributions and ground-truth tokens. The server updates model parameters using gradient-based optimization methods such as stochastic gradient descent or adaptive methods. The training process may employ data augmentation techniques such as paraphrasing, back-translation, or synthetic emotion annotations to increase robustness of the model to variations in user input. By designing the training data and the objective function to include emotional state conditioning, the resulting generative AI model becomes technically capable of using emotional features as control signals, which human operators cannot practically emulate at scale.

The server uses specific data structures to represent the various processing stages. For example, the server represents a session as a record including fields such as session identifier, user identifier, timestamp, character information, emotional state label, emotional scores, prompt sentence, and response information. The server represents the emotional scores as an array of floating-point values aligned with a fixed list of emotion categories. The server represents the prompt sentence as a sequence of token identifiers stored in a vector. These explicit data structures enable deterministic flow of information and facilitate debugging, logging, and optimization of the processing pipeline.

The server applies non-conventional rules in the prompt construction step that differ from simple human heuristic editing. For example, the server can automatically introduce meta-instructions into the prompt sentence based on the emotional state, such as requesting “gentle and reassuring language” for anxiety or “calm and de-escalating language” for anger, while restricting certain types of responses that are deemed inappropriate for the emotional state.

The server can also adjust the level of detail in the request to the generative AI model depending on the emotional probability distribution; when the probability distribution is uncertain, the server may instruct the model to generate clarifying questions rather than direct advice. These algorithmic rules for prompt sentence construction and parameter selection are executed consistently at machine speed and are embedded in the code and configuration of the server, providing a technical improvement in how generative models are controlled.

In one alternative embodiment, the terminal performs the speech recognition locally, using a speech recognition library installed on the terminal. The terminal converts audio information into character information, and the server receives the character information rather than the raw audio. In this case, the server still performs emotion analysis and generates the prompt sentence and response information as described above. This embodiment reduces bandwidth usage and offloads computation from the server to the terminal, which can be advantageous in environments with limited network capacity.

In another alternative embodiment, the server is configured to support different generative AI models with different architectures. The server can select a model depending on the detected emotional state or the length of the character information. For short, low-intensity emotional inputs, the server may use a smaller model to reduce latency. For long, high-intensity emotional inputs, the server may use a larger model with more parameters and deeper layers to obtain more nuanced responses. The server stores model selection rules in a configuration file or in a policy database and executes these rules as part of the pipeline, thereby improving computational efficiency.

The user interacts with the system in a natural manner by speaking into the terminal and receiving responses. The user does not need to manage any technical parameters. The server and the terminal handle the conversion, analysis, prompt generation, and generative response creation automatically in accordance with the described algorithms and data structures. The integration of emotional state evaluation and prompt sentence construction as machine-readable control information for the generative AI model constitutes a technical solution that changes the way the underlying computer system operates, improving response quality, processing speed, resource usage, and stability beyond a mere automation of human counseling workflows.

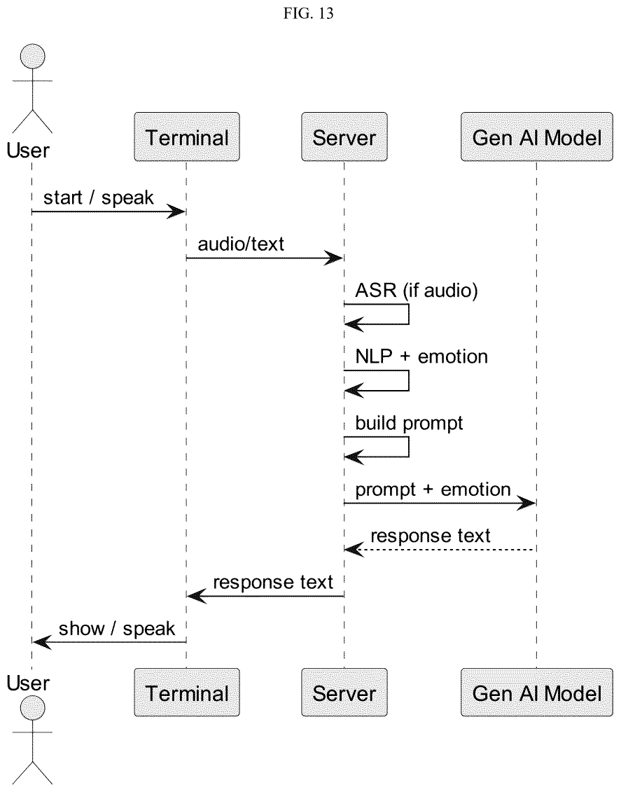

The following describes the processing flow using FIG. 13.

### Step 1:

The user activates a consultation function on the terminal.
The user operates a graphical user interface on the terminal to start a new session, for example by tapping a “Start consultation” button. The input is a user operation event detected by the terminal. The terminal uses this event to initialize a session identifier, clear previous buffers, and display an instruction message prompting the user to speak. The output is an initialized session state stored in the terminal memory and optionally in the server storage.

### Step 2:

The user speaks consultation content into the terminal.
The user provides acoustic speech describing a problem or concern towards the microphone of the terminal. The input is the user's voice as analog sound waves. The terminal converts the analog sound into digital samples using an analog-to-digital converter, with specified sampling rate and bit depth. The terminal stores the digital samples as audio information in a buffer in the memory. The output is a sequence of audio frames representing the user's utterance.

### Step 3:

The terminal preprocesses and optionally compresses the audio information.
The terminal receives the audio frames as input and applies preprocessing, such as noise reduction and voice activity detection, using digital signal processing algorithms executed on the terminal processor. The terminal then optionally encodes the preprocessed audio using a compression codec to reduce data size. The data processing consists of filtering, frame analysis, and re-encoding of the audio frames. The output is preprocessed audio information in a specified encoding format suitable for transmission.

### Step 4:

The terminal transmits the audio information or character information to the server.
The terminal takes the preprocessed audio information (or, in a variation, already converted character information) as input and constructs a network message that includes a session identifier, user identifier, and timestamp. The terminal uses a communication stack to open a secure channel and sends the message to a server endpoint. The data processing consists of packaging the audio or text into a structured request and performing encryption and protocol framing. The output is a network packet sequence delivered to the server.

### Step 5:

The server receives and stores the session data.
The server accepts the network packet sequence as input and reassembles the request. The server verifies headers, authenticates the request, and parses the payload to extract the session identifier and the audio or text content. The data processing includes JSON or binary parsing, validation checks, and insertion of metadata into a storage structure. The output is a stored session record that includes at least the raw audio information or character information and associated metadata.

### Step 6:

The server converts audio information into character information when audio is received.
The server takes the stored audio information as input and applies a speech recognition module. The server computes acoustic features from the audio frames, such as Mel-frequency cepstral coefficients, and inputs the features into an acoustic model and language model. The data processing includes feature extraction, probabilistic decoding, and mapping from phonetic units to text symbols. The output is character information in the form of a text string representing the user's utterance.

### Step 7:

The server tokenizes the character information and prepares it for emotion analysis.
The server receives the character information as input and applies a tokenizer associated with an emotion classification model. The server splits the text into subword units, maps each unit to an integer identifier using a vocabulary table, and pads or truncates the sequence to a predefined length. The data processing consists of lexical segmentation and numerical encoding of the text. The output is a token sequence and corresponding attention masks suitable for input to a neural network.

### Step 8:

The server evaluates the emotional state of the user using an emotion classification model.
The server takes the token sequence and attention masks as input and feeds them into a transformer-based classifier executed on the server processor or a dedicated accelerator. The server applies multiple self-attention and feed-forward layers to compute contextual representations, then applies a classification layer with a softmax function to obtain emotion probabilities. The data processing is a series of linear transformations, nonlinear activations, and normalization operations. The output is emotional state data including at least a primary emotion label and a probability distribution over predefined emotion categories.

### Step 9:

The server logs the character information and emotional state into persistent storage.
The server uses the character information and emotional state data as input and constructs a database record indexed by the session identifier. The server writes fields such as input text, primary emotion, emotion scores, and timestamps into a storage system. The data processing consists of formatting values into database columns and executing an insert or update operation. The output is a persistent record enabling later retrieval and analysis.

### Step 10:

The server generates an issue description from the character information.
The server accepts the character information and, optionally, the emotional state data as input and applies a summarization or key-phrase extraction algorithm. The server may run a lightweight neural summarization model or rule-based extraction routines to identify key sentences and phrases related to the user's concern. The data processing includes text segmentation, scoring of segments, and selection or rewriting of segments into a concise description. The output is an issue description text that captures the essential problem expressed by the user.

### Step 11:

The server constructs a prompt sentence that incorporates the issue description and emotional state.
The server takes the issue description and the primary emotion label as input and applies a template-based generation process. The server retrieves a template string from configuration, replaces placeholders with the issue description and emotion label, and optionally inserts additional meta-instructions for the generative AI model. The data processing consists of string substitution and concatenation operations. The output is a prompt sentence, for example:
“The user is troubled by tense relationships at the workplace and fears that colleagues dislike them. According to emotion analysis, the user feels anxiety. Provide an appropriate, empathetic, and practical advice.”

### Step 12:

The server attaches structured emotional state data to the prompt sentence.
The server receives the prompt sentence and emotional state data as input and converts the emotional state into a structured control representation, such as a tuple of numerical scores and a categorical label. The server associates this structure with the prompt sentence, for example by creating a data object that includes both the text and the emotional features. The data processing includes mapping the emotional scores to fixed positions in a vector and labeling them with category indices. The output is a combined prompt representation that includes both the prompt sentence and the emotional control data.

### Step 13:

The server encodes the combined prompt representation for input to a generative AI model.
The server takes the prompt sentence and emotional control data as input and tokenizes the prompt text using the vocabulary of the generative AI model. The server maps each token to an identifier and looks up corresponding embedding vectors. The server then incorporates the emotional control data, for example by adding an emotion embedding vector to each token embedding or by inserting special emotion tokens at the beginning of the sequence. The data processing consists of numerical embedding, vector addition, and sequence construction. The output is an input tensor representing the conditioned prompt ready for processing by the generative AI model.

### Step 14:

The server generates response information using the generative AI model.
The server provides the input tensor and generation parameters as input to a transformer-based generative AI model. The server performs iterative decoding: at each step, the model computes a probability distribution over vocabulary tokens based on the current hidden state, and the server selects the next token according to a decoding strategy such as greedy decoding or nucleus sampling. The data processing includes matrix multiplications in attention layers, non-linear activations, and probability computations at each decoding step. The output is a sequence of generated token identifiers, which the server then maps back to characters to form response text.

### Step 15:

The server post-processes the generated response text.
The server accepts the raw generated text as input and applies normalization and safety checks. The server may remove incomplete sentences at the end, correct basic formatting issues, and filter out prohibited content using rule-based checks or an auxiliary classification model. The data processing consists of string scanning, pattern matching, and conditional replacement or truncation. The output is cleaned response information suitable for presentation to the user.

### Step 16:

The server prepares and sends the response information to the terminal.
The server takes the finalized response text and associated session identifier as input and constructs a response message containing the response text and, optionally, the emotional state. The server encodes this message in a structured format and passes it to the network stack for transmission to the terminal. The data processing includes serialization, header insertion, and secure channel encryption. The output is a network response delivered to the terminal.

### Step 17:

The terminal receives and parses the response information.
The terminal accepts the network response as input and decodes the payload to extract the response text and any additional metadata. The terminal verifies the session identifier and associates the response with the correct conversation view. The data processing includes parsing of the structured format and mapping the fields to internal data structures. The output is a response object in the terminal memory containing the text to be displayed and any auxiliary information.

### Step 18:

The terminal presents the response information to the user.
The terminal takes the response object as input and updates the user interface by adding the response text to a display area, such as a chat window. The terminal may also generate an audio output by sending the response text to a text-to-speech engine and playing the synthesized audio through the speaker. The data processing consists of rendering text on the display, managing layout, and, for audio, converting text to phonemes and waveforms via the text-to-speech system. The output is visual and/or auditory presentation of the response, which the user can perceive.

### Step 19:

The user reviews the response and optionally provides follow-up input.
The user takes the presented response as input in a cognitive sense and decides whether to continue the interaction. The user may speak an additional question or clarification into the terminal. The practical effect is that new audio information becomes available to the terminal, which is handled again according to the previous steps, enabling an iterative refinement of advice based on updated character information and emotional state. The output is new user audio that initiates another cycle of processing in the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented consultation systems, such as rule-based chatbots or simple FAQ engines, are generally configured to process user input as static textual content without accurately modeling a user's emotional state or urgency. In typical architectures, a server receives user messages and selects a response from predefined templates or performs shallow pattern matching. Such systems exhibit several technical shortcomings.

First, conventional servers do not tightly integrate speech recognition, natural language understanding, emotion analysis, and generative response synthesis in a single coordinated processing pipeline. As a result, processing of user input is fragmented, requires multiple disjoint calls, and often loses contextual signals such as emotional intensity or emergency indicators. This leads to suboptimal utilization of computation and network resources, and generates responses that are poorly aligned with the user's actual psychological condition.

Second, existing systems do not systematically construct machine-readable instruction sequences, i.e., prompt sentences, that encode both semantic content and detected emotion for a downstream generative AI model. In many cases, the generative model is invoked with generic prompts that ignore emotion scores, urgency levels, or domain-specific constraints. This causes the generative model to perform additional inference to infer context, increasing processing latency and computational load, and often producing responses that are either overly generic, excessively long, or inappropriate in tone.

Third, conventional routing modules in server systems typically classify messages only by topic or keyword and do not adjust priority or escalation paths based on a computed emotional state. Therefore, urgent or high-risk situations, such as fear, panic, or significant distress, may be processed with the same priority as non-urgent queries. This results in inefficient allocation of processing resources, delayed notification to external services, and reduced reliability from the perspective of system behavior under stress conditions.

Fourth, known systems generally lack a unified mechanism by which the server transforms raw multi-modal user input (voice and text) into a structured representation that directly drives both (i) generation of psychologically considerate responses and (ii) targeted interaction with external information processing apparatuses. Without such a mechanism, the system must perform redundant parsing and classification across different subsystems, which increases processing overhead, introduces inconsistencies, and complicates scaling.

Accordingly, there is a need for an improved computer system and server-side processing architecture that (i) captures user input via voice or text, (ii) converts voice to character information, (iii) performs integrated natural language verification and emotion analysis to estimate emotional state and urgency, (iv) constructs a prompt sentence encoding content, emotion, urgency, and response constraints, (v) invokes a generative AI model based on the constructed prompt sentence to generate psychologically considerate responses, and (vi) automatically cooperates with external information processing apparatuses for notification and information distribution based on the computed emotion and urgency. By reorganizing the processing pipeline in this manner, the server can improve the technical quality of response generation, reduce redundant computation, and enhance the timeliness and appropriateness of system-level behavior in emotion-sensitive scenarios.

The specific processing by the specific processing unit 290 of the data processing device 12 in Application Example 2 is realized by the following means.

The present invention provides a server comprising a processor configured to receive information from a user via voice input or text input, convert voice information into character information, verify the character information and analyze a content and a domain of the information by natural language processing, perform emotion analysis on the character information and estimate an emotional state and an urgency level of the user, construct a prompt sentence for input to a generative AI model on the basis of the content of the information, the emotional state, and the urgency level, input the prompt sentence to the generative AI model and generate a response including psychological consideration in accordance with the emotional state and the urgency level, transmit the response to a user terminal and present the response by display or audio output, and cooperate with an external information processing apparatus in accordance with the emotional state and the urgency level to perform notification or information distribution. This enables an integrated computer-implemented processing pipeline in which multi-modal user input is transformed into a structured representation of content, emotion, and urgency, such that the server can efficiently guide a generative AI model using a context-rich prompt sentence, generate technically improved responses that are aligned with the user's emotional condition, and dynamically route information and notifications to external apparatuses with appropriate priority, thereby improving overall system performance, responsiveness, and reliability in emotion-aware consultation environments.

The term “information” refers to user-provided data including at least one of voice input and text input that expresses a consultation, inquiry, or statement to be processed by the system.

The term “voice input” refers to audio data representing spoken utterances of a user, captured by an input device such as a microphone and encoded as a digital signal.

The term “text input” refers to character data representing user-provided content entered through a user interface such as a keyboard, touch screen, or text field.

The term “voice information” refers to digital audio data obtained from the voice input of a user before conversion into character information.

The term “character information” refers to symbolic data including characters, words, and sentences generated by converting voice information or directly obtained as text input, and used for natural language processing and analysis.

The term “natural language processing” refers to a set of computational techniques for analyzing, interpreting, and transforming character information expressed in a human language into structured data such as tokens, parts of speech, entities, topics, and semantic representations.

The term “verify the character information” refers to processing that checks the character information for at least one of completeness, coherence, grammatical correctness, domain relevance, and suitability for further automated handling.

The term “content of the information” refers to semantic aspects of the character information, including topics, entities, events, and user intents expressed in the information.

The term “domain of the information” refers to a classification category to which the content of the information belongs, such as security-related issues, educational issues, workplace issues, or mental-health-related issues.

The term “emotion analysis” refers to computational processing of character information to estimate an emotional state of a user by applying at least one of statistical models and machine learning models to derive emotion labels and associated scores.

The term “emotional state” refers to a representation of a user's psychological condition inferred from the information, including at least one of anxiety, fear, sadness, anger, frustration, calmness, and combinations thereof, optionally with quantified intensities.

The term “urgency level” refers to a quantitative or categorical indication of how promptly the system should respond or escalate a case, derived from the emotional state and the content of the information, including at least one of normal, high, and emergency.

The term “prompt sentence” refers to a machine-readable instruction sequence formed as natural language text that encodes the content of the information, the emotional state, the urgency level, and response constraints, and that is supplied as input to a generative AI model to guide response generation.

The term “construct a prompt sentence” refers to assembling, formatting, and parameterizing text that describes the user's situation, emotional state, urgency level, and required response properties, in order to control behavior of a generative AI model.

The term “generative AI model” refers to a trained machine learning model that receives a prompt sentence and produces generated text as an output, the generated text including at least a response to the user information, and implemented for example as a large language model.

The term “response including psychological consideration” refers to generated text that is configured to take into account the emotional state and urgency level of the user, and that is phrased to provide empathy, reassurance, and appropriate guidance rather than purely factual content.

The term “user terminal” refers to an electronic device operated by a user to transmit information to the server and receive a response, including at least one of a smartphone, a tablet computer, a personal computer, and a wearable device.

The term “present the response by display or audio output” refers to outputting the generated response on the user terminal in a human-perceivable form, including at least one of presenting text on a screen and reproducing synthesized or recorded audio via a speaker or earphone.

The term “external information processing apparatus” refers to a computing system separate from the server that is configured to receive data from the server and execute additional processing, such as providing specialized services, handling emergency notifications, or performing departmental workflows.

The term “notification” refers to a message transmitted from the server to the external information processing apparatus or to a predefined contact, containing at least part of the information, the emotional state, the urgency level, or the response, for the purpose of alerting or requesting action.

The term “information distribution” refers to transmission of information, including at least one of the original content, analysis results, and generated responses, from the server to one or more external information processing apparatuses selected on the basis of the content of the information, the emotional state, and the urgency level.

In one embodiment, a server, a terminal, and a user cooperate to implement the claimed system. The server includes at least one processor, a memory, a non-transitory storage device, and a network interface. The terminal includes at least one processor, a memory, a microphone, a display unit, an audio output unit, and a communication interface. The user operates the terminal to provide information to the server and to receive responses from the server.

The terminal acquires user information as either voice input or text input. The terminal uses an audio input device, such as a built-in microphone controlled through an operating system audio application programming interface, to convert analog voice signals into digital audio samples. The terminal may use a sampling frequency of 16 kHz, linear pulse-code modulation encoding, and mono channel format. The terminal stores the sampled audio in a buffer structure in memory, for example as a sequence of frames each containing a fixed number of samples. The terminal also acquires text input through a keyboard interface, a touch interface, or a speech-to-text module. The terminal encapsulates the acquired user information and associated metadata, such as timestamps, language codes, and user identifiers, into a structured message, for example a record with fields representing raw audio data, optional recognized text, and context parameters. The terminal transmits the structured message to the server over a packet-based network using a transport protocol such as TCP/IP and a secure application protocol such as HTTPS.

The server receives the structured message via the network interface and stores the message in a memory-resident input queue managed by the processor. The server parses the message to determine whether the user information includes audio data, text data, or both. When audio data is present, the server converts the voice information into character information. The server uses speech recognition software, such as a remote speech recognition service accessible through an application programming interface or an on-premises speech recognition library, which internally implements an acoustic model, a pronunciation model, and a language model. The speech recognition software performs feature extraction, for example by computing Mel-frequency cepstral coefficients from the audio frames and constructing feature vectors. The speech recognition software then applies a sequence-to-sequence model, such as a recurrent neural network or a transformer-based model trained to map acoustic feature sequences to token sequences. The server receives recognized text output from the speech recognition software as character information, for example as a Unicode string, and stores it in association with an internal consultation identifier.

The server performs natural language processing on the character information to verify the content and analyze a domain of the information. The server uses a natural language processing module, which may include tokenization, lemmatization, part-of-speech tagging, and named entity recognition. In one embodiment, the natural language processing module uses a statistical model or a neural sequence labeling model that processes word embeddings or subword token embeddings to assign linguistic tags to each token. The server constructs a data structure representing the verified character information, which may contain a token list, part-of-speech tags, entities, and a topic label. The server checks for incomplete sentences, non-linguistic noise, or unsupported content types and may normalize spelling and punctuation. By performing verification and normalization, the server reduces error propagation into later modules and improves data quality used for subsequent computation.

The server performs emotion analysis on the verified character information to estimate an emotional state and an urgency level of the user. In one embodiment, the server uses an emotion analysis model implemented as a neural network model, such as a transformer-based classifier. The server converts the tokens into numerical vectors using an embedding layer, applies a stack of attention layers that compute contextual representations of the tokens, and aggregates the representations using an attention pooling or classification token mechanism.

The server feeds the aggregated representation into a fully connected layer and a softmax output layer to obtain a probability distribution over predefined emotion classes, such as anxiety, fear, sadness, anger, calmness, and neutral. The server also computes a continuous urgency score based on a weighted combination of the probabilities and the presence of specific lexical markers associated with urgency, such as words indicating immediate danger or severe distress. The server stores the emotion analysis result in an emotion state record, which may include a primary emotion label, secondary emotion labels, probability scores, and an urgency level category.

In some embodiments, the server further refines the emotional state by incorporating acoustic features extracted from the original voice information. The server may compute pitch contours, energy measures, and speech rate from the audio frames and feed these features into a secondary model, such as a recurrent neural network or a convolutional neural network, that outputs prosodic emotion indicators. The server then combines the text-based emotion scores and the prosodic emotion indicators using a fusion algorithm, for example a weighted averaging or a small neural network, to generate a more robust emotional state estimation. This multimodal fusion reduces sensitivity to noise in either text or audio alone and improves overall accuracy of the estimated emotional state and urgency level.

The server constructs a prompt sentence for input to a generative AI model based on the verified character information, the emotional state, and the urgency level. The server uses a prompt construction module, which implements a set of deterministic rules and parameterized templates stored in memory. The server selects a template according to the domain of the information and the urgency level. The template may specify sections such as a summary of the user's statement, an explicit description of the emotional state, constraints on tone and length, and required advice elements. The server fills the template with content parameters, such as the main text of the user's consultation, the primary emotion label, and the urgency level. The server may also include instruction clauses that specify response behavior for the generative AI model, for example instructing the model to avoid certain types of content or to emphasize safety measures. The server thereby generates a context-rich prompt sentence that encodes a structured representation of both semantic content and emotional context in a single natural language instruction stream.

In one example, the server constructs the following prompt sentence when the user expresses concern about security:
“The user says: ‘Recently, I'm worried about online fraud.’ Emotion analysis indicates high anxiety. As a calm and supportive assistant, generate a brief answer that validates the user's feelings and lists 3 simple, concrete steps to improve online security. Avoid technical jargon.”

In another example, the server constructs the following prompt sentence when the user reports school bullying:
“The user says: ‘I am being bullied at school.’ The emotion engine detects strong sadness and fear. Generate an empathetic response that (1) acknowledges that the situation is very hard, (2) reassures the user that they are not at fault, and (3) suggests safe actions such as talking to trusted adults, school counselors, or official support lines.”

In another example, the server constructs the following prompt sentence when the user reports an emergency situation:
“The user says: ‘Someone is following me and I'm scared.’ Treat this as a potential emergency. First, generate a very short and clear message to help the user stay calm and safe right now. Second, briefly list what information (for example, location, time, description) should be sent to an emergency contact. Use simple and direct language.”

The server inputs the constructed prompt sentence to a generative AI model configured as a language generation model. In one embodiment, the generative AI model is implemented as a transformer-based neural network trained on a large corpus of text data. The generative AI model includes an embedding layer, multiple self-attention layers, feed-forward layers, and a final softmax output layer that generates probability distributions over a vocabulary of tokens at each decoding step. The generative AI model has parameters including weight matrices and bias vectors that are optimized during a training phase using a loss function such as cross-entropy between predicted token distributions and ground-truth tokens from training sequences.

During training, a learning module updates the weights of the generative AI model by computing gradients of the loss function with respect to the model parameters using backpropagation and an optimization algorithm such as stochastic gradient descent or Adam. The training procedure may use data augmentation techniques, such as random masking or shuffling, to improve generalization. The generative AI model, once trained, is stored in a parameter file and loaded by the server or a remote computation service.

During inference, the server passes the prompt sentence through the generative AI model. The generative AI model encodes the prompt sentence into internal hidden representations and successively generates output tokens based on previously generated tokens and the prompt representations. The server may constrain the generation process using parameters such as maximum length, temperature, and top-k or top-p sampling thresholds to control diversity and relevance of the generated text. The server receives a candidate response from the generative AI model as a sequence of tokens and converts the sequence into character information.

The server may apply a post-processing module to the generated response to ensure consistency with the emotional state and system policies. The post-processing module may remove or modify segments that conflict with safety constraints or domain restrictions. The server may also adjust the length of the response by truncating or requesting regeneration with modified constraints, such as an instruction to make the answer shorter or more reassuring, when the initial output does not match predefined criteria.

The server then transmits the generated response to the terminal. The response may be encapsulated in a structured record containing at least the response text, emotion tags, urgency level, and optional external references. The terminal receives the record and presents the response either as on-screen text or as audio output. When audio output is used, the terminal employs text-to-speech software, which may be integrated in the operating system, to convert the character information into synthesized speech signals, which the terminal outputs through a speaker or a connected audio device. The terminal may adapt the display layout and font size for readability and may highlight key action phrases when the urgency level is high.

The server also cooperates with an external information processing apparatus in accordance with the emotional state and the urgency level to perform notification or information distribution. The server consults a routing configuration stored in a repository that maps domains and urgency levels to external services or departments, such as emergency response entities, counseling services, or security advisory services. The server selects an external information processing apparatus according to the content of the information and the computed emotional state and urgency level. The server constructs a notification message including identifiers, a summary of the user's situation, the emotional state, the urgency level, and relevant context such as approximate location when available. The server transmits the notification message using an interface such as a web service application programming interface, a message queue, or an email gateway. This enables automated, technically directed routing of critical information to appropriate external systems, with priority and content determined by computational analysis rather than static rules.

By designing the system in this way, the server improves computer technology itself, rather than merely automating a human counselor's behavior. The integrated pipeline reduces redundant passes over the data: voice information is converted once to character information, verified once, and then reused by both the emotion analysis and prompt construction modules. The use of a unified emotion state record avoids multiple, inconsistent emotion evaluations by separate modules and reduces the number of network calls to external services. This leads to lower latency and reduced communication overhead compared with a naive sequential composition of independent services.

The specific structure of the generative AI model and the prompt construction process improves the quality and technical precision of response generation. By encoding emotional state and urgency level directly into the prompt sentence as structured instructions, the server allows the generative AI model to condition its internal attention and decoding on explicit context, reducing the need for the model to infer emotion solely from raw user text. This reduces computational burden inside the generative AI model and increases stability of output, thereby improving processing speed and accuracy. The prompt templates and rule-based constraints implement non-conventional pre-processing that reconfigures generic language models into specialized engines for emotion-aware responses without requiring retraining of the models.

The emotion analysis module uses a neural architecture and feature extraction methods that are configured specifically to detect subtle differences between similar textual patterns and to map them to a continuous urgency scale. This differs from conventional rule-based keyword matching by computing multi-dimensional embeddings that capture contextual relationships. Through supervised learning with labeled emotion corpora, the model learns a decision surface in embedding space that can separate, for example, ordinary concern from high-risk panic. This technical arrangement leads to a reduction in false negatives and false positives in urgency detection, which in turn improves the reliability of notification behavior and allocation of processing resources.

The system also optimizes data structures for the internal representations of consultations. The server stores, for each consultation, a record that contains fields for raw audio references, recognized text, linguistic annotations, emotion scores, prompt parameters, generated responses, and routing decisions. By using this structured record, the server can avoid reconstructing intermediate representations and can replay or refine later stages, such as re-generating a response with modified prompt constraints, without re-running expensive earlier computations. This data management approach improves memory utilization and decreases overall computation time in multi-stage processing.

In another embodiment, the server may run the generative AI model locally on dedicated hardware accelerators such as graphics processing units or tensor processing units. In such a configuration, the server schedules model execution in batches when multiple prompt sentences are ready, thereby exploiting parallelism across consultations. The server may also quantize model weights or apply model distillation to reduce memory footprint and computational cost while retaining sufficient performance. This provides a technical scaling advantage and reduces latency for high-volume deployments.

In yet another embodiment, the emotion analysis and prompt construction modules can be deployed partly on the terminal. The terminal can perform lightweight pre-classification of domain and emotion, using smaller models optimized for mobile processors. The terminal then sends only compressed feature vectors or high-level emotion summaries to the server, thereby reducing network bandwidth usage and protecting privacy by minimizing raw text transmission. The server can reconstruct an extended emotion state from these compressed features and proceed with prompt construction and generation. This distributed configuration reduces communication load and balances computation between the terminal and the server, which is a technical effect not achieved by traditional centralized chat systems.

In further variants, the server can adapt the internal threshold parameters used to decide when to escalate to external information processing apparatuses. The server can monitor empirical distributions of emotion scores and observed outcomes, and adjust decision boundaries to maintain target false-alarm rates. This dynamic adaptation uses statistical feedback to improve routing performance over time, which is a form of technical optimization of the classification pipeline.

By combining these modules—speech recognition, natural language verification, emotion analysis, prompt construction, generative AI inference, and automated external routing—into a coherent architecture with specific data structures, neural models, and rule-based control logic, the system produces measurable technical benefits. The server reduces processing latency by minimizing redundant analysis passes; the server improves accuracy in detecting emotional state and urgency through specialized neural architectures; the server decreases communication overhead by performing selective, priority-based notifications; and the server enables scalable, resource-efficient response generation tailored to user emotion. These improvements arise from the particular configuration, data flow, and algorithmic design of the system, rather than from mere substitution of a human counselor with a generic computer.

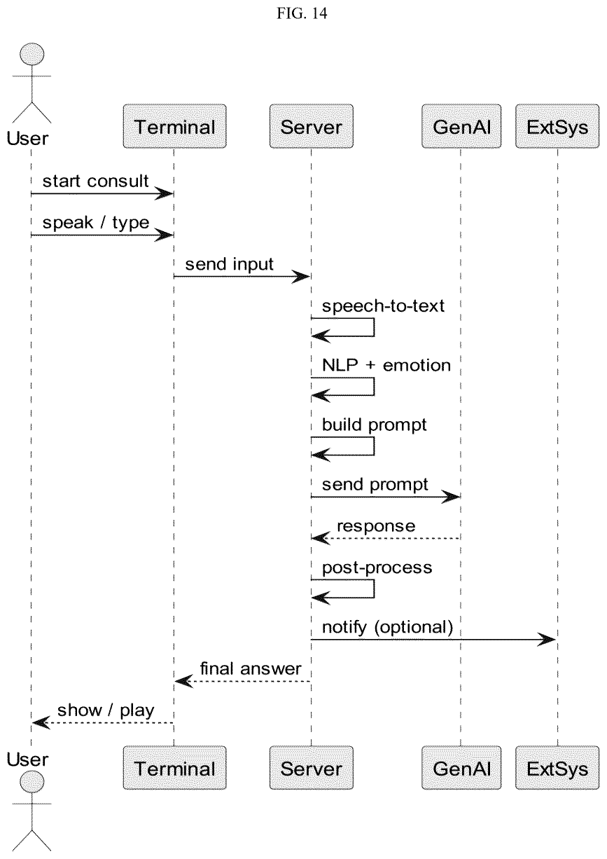

The following describes the processing flow using FIG. 14.

### Step 1:

User operates the terminal to start a consultation session.
User selects a consultation mode (voice or text) on an application running on the terminal and provides information, such as a concern or question.
Input: User's spoken utterance or typed text.
Output: User interaction events (button presses, field focus, etc.) and initial raw content captured by the terminal.
Terminal captures these interaction events and initializes internal data structures (for example, a consultation record with fields for user ID, timestamp, and input mode) to store subsequent data.

### Step 2:

Terminal acquires voice or text input from the user.
Terminal, when in voice mode, activates a microphone through an operating system audio interface, samples the analog audio signal at a predetermined sampling rate, and writes successive frames of audio samples into a buffer.
Terminal, when in text mode, captures keystrokes or touch-screen input and aggregates the characters into a text string in an input field.
Input: For voice mode, analog speech signal; for text mode, user keystrokes or touch input.
Output: For voice mode, digital audio data (for example, 16 kHz PCM frames); for text mode, a text string expressing the user's message.
Terminal performs basic preprocessing on the input, such as trimming leading and trailing silence in audio or removing illegal characters in text, and stores the cleaned data into a local consultation object.

### Step 3:

Terminal packages and transmits the user information to the server.
Terminal constructs a structured message containing at least the raw audio data or text string, along with metadata such as language code, device identifier, and timestamps.
Input: Local consultation object including voice data or text and metadata.
Output: Network message (for example, an HTTPS request body) sent to the server.
Terminal serializes the data into a specific format, attaches authentication tokens as necessary, and sends the message using a secure network protocol to a designated server endpoint.

### Step 4:

Server receives and stores the incoming consultation data.
Server accepts the network message via a communication module, verifies authorization, and parses the payload to extract audio or text content and metadata.
Input: Network message from the terminal containing consultation data.
Output: Internal consultation record stored in memory or a database, with references to raw audio and/or text.
Server creates or updates a structured consultation record, assigning an internal consultation identifier and storing references to the content in appropriate storage (for example, a file path for audio and a text field for text input).

### Step 5:

Server converts voice information into character information when needed.
Server checks the consultation record to determine whether audio data is present and text data is missing or incomplete.
Input: Consultation record containing digital audio data.
Output: Character information (recognized text) added to the consultation record.
Server sends the audio data to a speech recognition component, which performs feature extraction (for example, computing Mel-frequency coefficients) and passes the features through an acoustic and language model to produce a sequence of text tokens.
Server receives the recognized text from the speech recognition component, converts the token sequence into a character string, and stores the string in the consultation record.

### Step 6:

Server performs natural language verification and domain analysis on the character information.
Server loads the character information from the consultation record and applies natural language processing routines such as tokenization, part-of-speech tagging, and entity recognition.
Input: Character information (user's message as text).
Output: Verified and annotated text, including tokens, tags, entities, and a domain label.
Server detects incomplete or malformed sentences, filters obvious noise, and normalizes text (for example, expanding common abbreviations, correcting repeated punctuation).
Server classifies the domain (for example, security concern, school issue, workplace problem) by feeding feature representations of the text to a classifier model or rule engine and writes the domain label and cleaned text back into the consultation record.

### Step 7:

Server performs emotion analysis to determine the emotional state and urgency level of the user.
Server takes the verified text and converts each token into a numerical vector using an embedding table, then feeds the sequence of vectors into an emotion analysis neural network such as a transformer-based classifier.
Input: Verified text with tokens and domain information.
Output: Emotion state data including predicted emotion labels, scores, and an urgency level.
Server runs the network forward pass to compute a hidden representation of the entire text and applies an output layer to obtain a probability distribution over emotion classes.
Server computes an urgency level by combining the emotion scores with rule-based checks for specific high-risk words or phrases and stores the resulting emotional state and urgency level into the consultation record.

### Step 8:

Server optionally refines the emotional state using acoustic features.
Server, when original audio is available, extracts prosodic features such as pitch trace, energy, and speech rate from the audio frames.
Input: Digital audio data and initial emotion scores from text analysis.
Output: Refined emotion scores and updated urgency level.
Server feeds the prosodic feature sequence into a secondary model, such as a recurrent neural network trained for emotion-from-voice classification, and obtains additional emotion probability scores.
Server combines text-based scores and prosodic scores using a fusion method (for example, weighted averaging or a small fully connected network) to produce a refined emotional state, which is then recorded in the consultation record and may increase or decrease the urgency level.

### Step 9:

Server determines whether escalation or routing is required based on content and emotional state.
Server evaluates the domain label, primary emotion, and urgency level, and checks internal routing rules stored in a configuration table.
Input: Consultation record containing domain, emotional state, and urgency level.
Output: Routing decision indicating whether to escalate, and selected external apparatus information if escalation is required.
Server performs a lookup in the configuration table, which maps combinations of domains and urgency levels to external information processing apparatus types or none.
Server sets a routing flag and target apparatus identifier in the consultation record when escalation is indicated; otherwise, server marks the case as normal or low priority.

### Step 10:

Server constructs a prompt sentence for input to the generative AI model.
Server selects a prompt template based on the identified domain and urgency level, then fills template fields using the user's original text, the primary emotion label, and any constraints derived from the routing and policy rules.
Input: Verified text, emotion state, urgency level, and domain label.
Output: Prompt sentence text containing an instruction to the generative AI model.
Server inserts explicit descriptions of the user's feelings, required tone (for example, calm, empathetic), desired length, and specific advice to be included into the template.
Server, for example, may generate a prompt sentence such as: “The user says: ‘Recently, I'm worried about online fraud.’ Emotion analysis indicates high anxiety. As a calm and supportive assistant, generate a brief answer that validates the user's feelings and lists 3 simple, concrete steps to improve online security. Avoid technical jargon.”
Server writes the constructed prompt sentence into the consultation record.

### Step 11:

Server invokes the generative AI model to generate a response.
Server sends the prompt sentence to a generative AI model, such as a transformer-based language model, by providing the prompt as input and specifying parameters like maximum tokens and sampling strategy.
Input: Prompt sentence text and generation parameters.
Output: Generated response text (candidate answer) from the generative AI model.
Server passes the prompt tokens through the generative AI model, which encodes the prompt and then decodes output tokens one by one by computing attention weights and probability distributions over a vocabulary at each step.
Server collects the output tokens until a stopping condition is met (for example, end-of-sequence token or length limit) and concatenates them into a response string, which is then attached to the consultation record as the initial generated response.

### Step 12:

Server post-processes the generated response and ensures alignment with emotional state and policies.
Server analyzes the generated response using text filters and simple classifiers to detect any prohibited content or inappropriate tone relative to the stored emotional state and urgency level.
Input: Generated response text and emotional state data.
Output: Final adjusted response text ready to be delivered to the user.
Server may truncate unnecessary long sections, rephrase parts by requesting a shorter or more focused answer from the generative AI model using a revised prompt sentence, or append additional clarifications (for example, reminders about safety or limits of advice).
Server then marks the adjusted response as the final response in the consultation record.

### Step 13:

Server prepares optional notifications and external information distribution.
Server checks the routing decision in the consultation record; if escalation is required, server composes a notification message summarizing the user's situation and including emotion and urgency indicators.
Input: Consultation record including routing flag, emotional state, urgency level, and possibly the generated response.
Output: Notification message ready to be transmitted to one or more external information processing apparatuses.
Server selects appropriate external endpoints according to the routing configuration, populates required fields such as identifiers, time, domain, and risk level, and serializes the notification into a format accepted by the external apparatus.
Server stores the notification status and any external identifiers back into the consultation record for tracking.

### Step 14:

Server transmits the final response (and, if applicable, notification status) to the terminal.
Server creates an output message containing the final response text, emotional state indicators (if desired for client display), urgency level, and optional information about external actions taken.
Input: Final response text and associated metadata from the consultation record.
Output: Network response message sent to the terminal.
Server sends the message to the terminal using a response channel associated with the original request, ensuring that it corresponds to the correct consultation identifier.

### Step 15:

Terminal receives and presents the response to the user.
Terminal parses the response message, extracts the response text, and any associated flags or metadata.
Input: Network response message from the server containing the final response and optional metadata.
Output: Visual or audio presentation of the response on the terminal.
Terminal renders the response text on a display using a user interface layout, possibly highlighting key advice when urgency is high, or invokes a text-to-speech engine to generate synthetic speech and plays the audio to the user.
User reads or listens to the response and may decide to continue the consultation, in which case the sequence starting from Step 1 is repeated for follow-up input.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

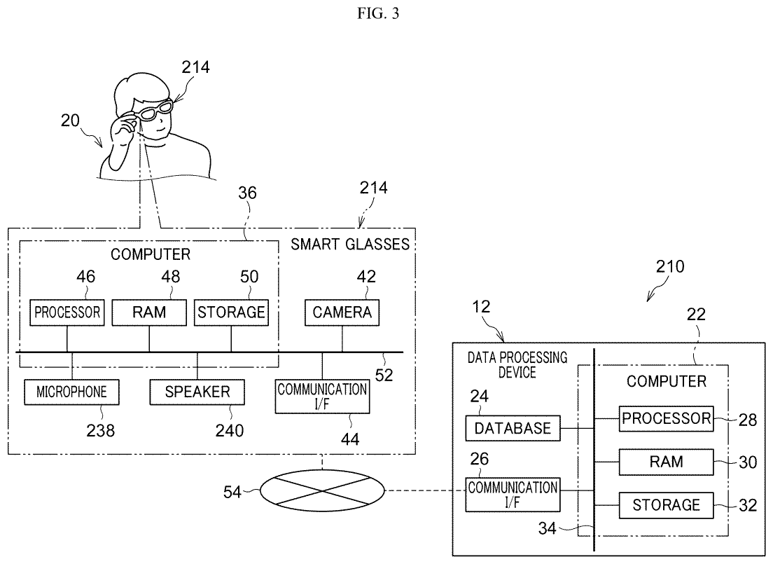

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

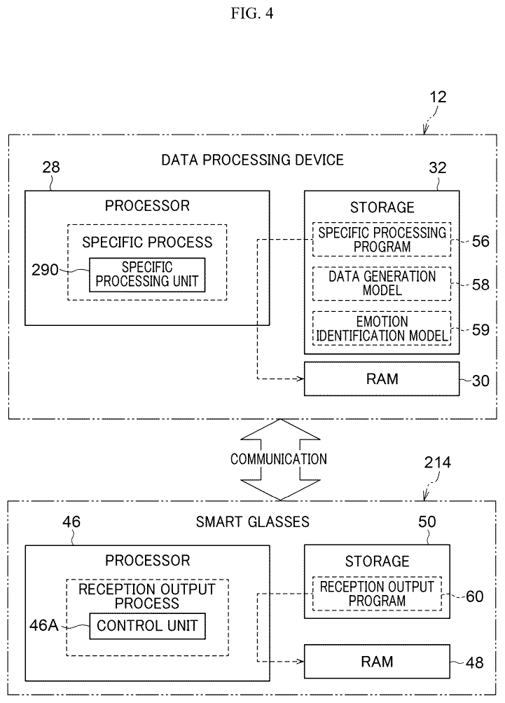

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

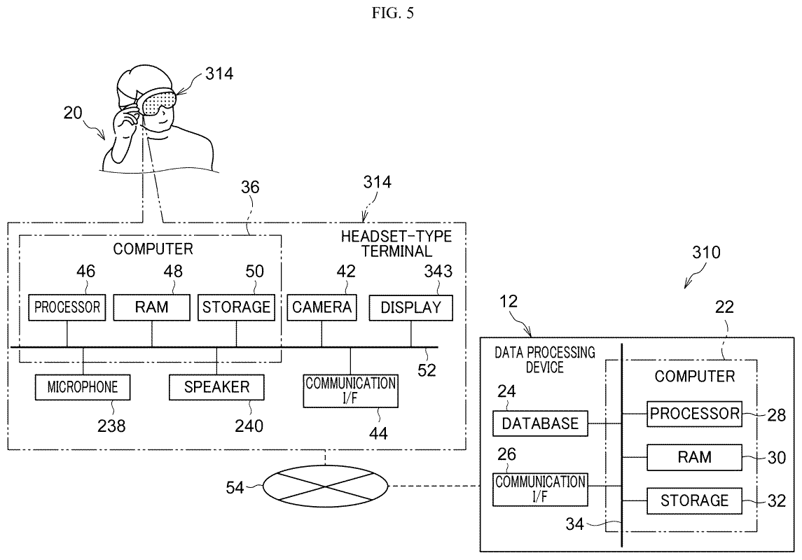

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

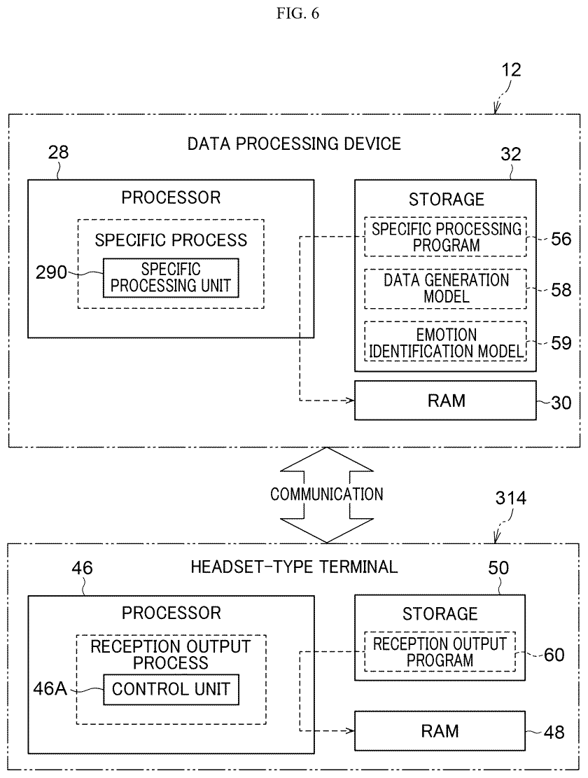

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

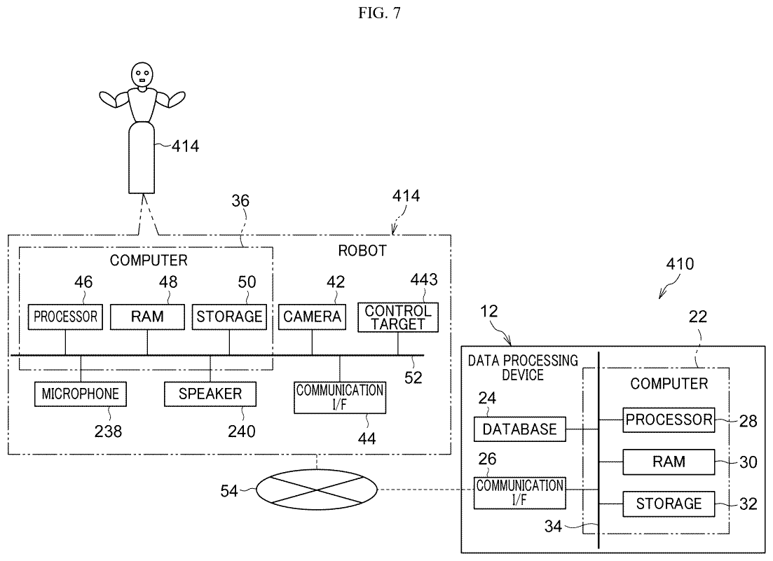

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

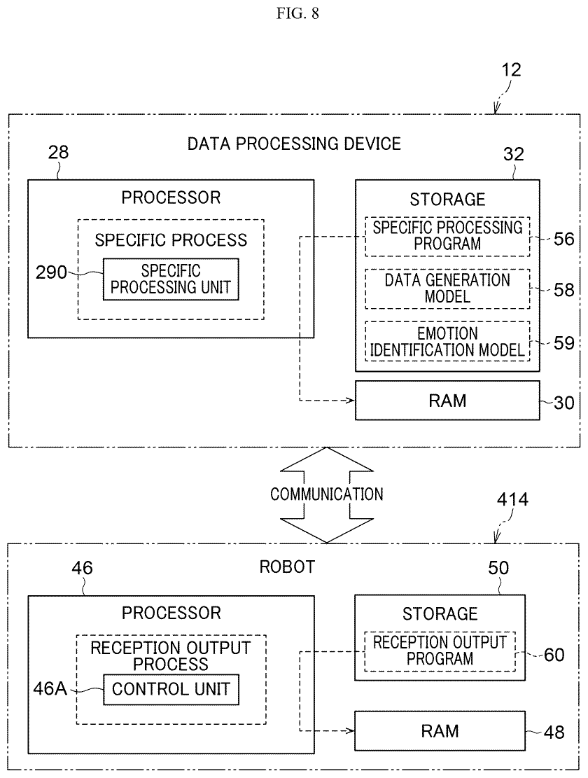

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

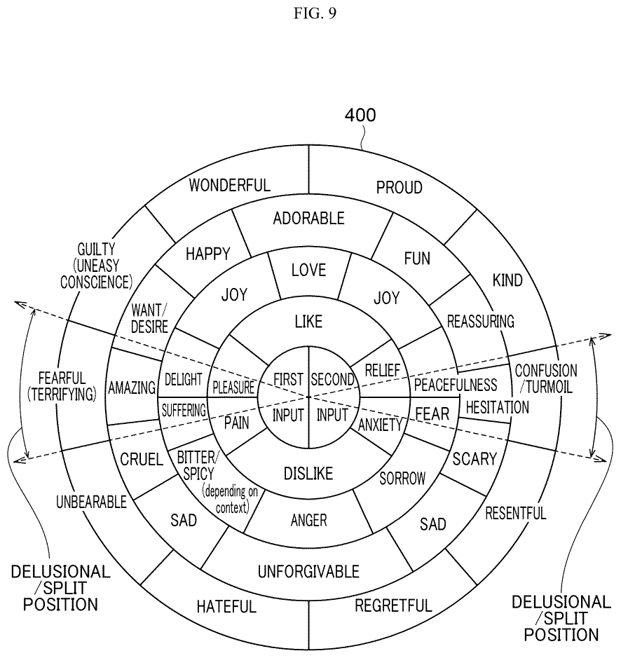

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

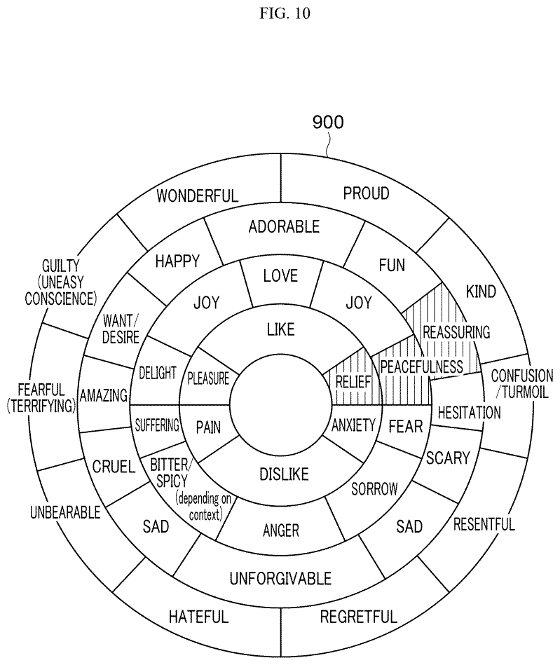

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire natural language information input from a user terminal, perform language analysis processing including structural analysis and phrase extraction on the natural language information, and generate analysis result data indicating content and intent of the natural language information; and
generate, on the basis of the analysis result data and emotion analysis result data indicating an emotional state of a user, a prompt sentence that defines a tone and explanatory content of a response, provide the prompt sentence as an input to a generative AI model, and cause the generative AI model to generate a response sentence including psychological consideration; and
perform, on the basis of phrases or identification information extracted from the natural language information, a query to an external information processing apparatus or an external information storage apparatus via a communication interface, acquire external information, and associate the external information with the analysis result data and integrate the external information into at least one of the prompt sentence and the response sentence; and receive voice information, convert the voice information into character information by performing acoustic analysis and speech recognition processing, and supply converted character information as the natural language information to the language analysis processing; and
format the response sentence generated by the generative AI model as display data, and transmit the display data to the user terminal for presentation to the user.

### (Supplementary 2)

The system according to supplementary 1,
wherein the processor is configured to, when generating the prompt sentence, automatically determine attribute information indicating at least one of a business field and a processing entity that is a target of inquiry on the basis of the analysis result data and the external information, and include an instruction sentence containing the attribute information as part of an input to the generative AI model.

### (Supplementary 3)

The system according to supplementary 1,
wherein the processor is configured to set priority information indicating at least one of a level of detail of information provision, an order of explanation, and a length of the response sentence in accordance with a psychological state of the user based on the emotion analysis result data, and reflect the priority information in the prompt sentence so as to control content and presentation order of the response sentence generated by the generative AI model.

### Application Example 1

### (Supplementary 1)

A system comprising a processor,
wherein the processor is configured to
receive consultation content from a user as audio information or character information and store the consultation content as comprehensive feature information, convert audio information included in the consultation content into character information by using a speech recognition technique and generate a consultation text based on a conversion result,
perform morphological analysis, syntactic analysis, and semantic analysis on the consultation text by using a natural language processing technique and extract important terms including terms indicating safety concerns and terms indicating a psychological state, and contextual information,
construct a prompt sentence including conditions for generation of a psychologically considerate response and conditions for cooperation with an external organization or an external division, based on the consultation text, the important terms, and the contextual information,
input the prompt sentence into a generative artificial intelligence model, cause the generative artificial intelligence model to generate a response text including psychological consideration, and transmit the response text to a user terminal, and evaluate a risk level or an urgency level of the consultation content based on the important terms and the contextual information, and, in accordance with an evaluation result, transmit the consultation content or summary information thereof to an external information processing apparatus via an application programming interface.

### (Supplementary 2)

The system according to supplementary 1,
wherein the processor is configured to construct the prompt sentence so as to include condition descriptions for automatically identifying a related business function or organizational unit corresponding to the consultation content, based on the important terms and the contextual information extracted from the consultation text.

### (Supplementary 3)

The system according to supplementary 1,
wherein the processor is configured to set a priority of the consultation content based on emotion analysis of the consultation text and the important terms, and select a type of the external information processing apparatus or an allocation destination within the external information processing apparatus, in accordance with the priority.

### Example 2

### (Supplementary 1)

A system comprising a processor,
wherein the processor is configured to
acquire audio information from a user via a user apparatus,
convert the audio information into character information,
analyze the character information to evaluate an emotional state of the user,
generate a prompt sentence including a situation of the user and the emotional state of the user, based on the character information and the emotional state,
input the prompt sentence to a generative information processing model to generate response information including psychological consideration for the user, and present the response information to the user apparatus.

### (Supplementary 2)

The system according to supplementary 1,
wherein the processor is configured to
summarize or extract a consultation content of the user based on the character information and the emotional state, and include a result of the summarization or extraction in the prompt sentence.

### (Supplementary 3)

The system according to supplementary 1,
wherein the processor is configured to
attach data indicating the emotional state to the prompt sentence, input the prompt sentence with the data indicating the emotional state to the generative information processing model, and cause the generative information processing model to generate an expression format and advice content in accordance with the emotional state.

### Application Example 2

### (Supplementary 1)

A system comprising a processor,
wherein the processor is configured to
receive information from a user via voice input or text input,
convert voice information into character information,
verify the character information and analyze a content and a domain of the information by natural language processing,
perform emotion analysis on the character information and estimate an emotional state and an urgency level of the user,
construct a prompt sentence for input to a generative AI model on the basis of the content of the information, the emotional state, and the urgency level,
input the prompt sentence to the generative AI model and generate a response including psychological consideration in accordance with the emotional state and the urgency level,
transmit the response to a user terminal and present the response by display or audio output, and
cooperate with an external information processing apparatus in accordance with the emotional state and the urgency level to perform notification or information distribution.

### (Supplementary 2)

The system according to supplementary 1,
wherein the processor is configured to include in the constructed prompt sentence conditions specifying a tone of the response, a length of the response, and advisory content to be included in the response in accordance with the content of the information, the emotional state, and the urgency level.

### (Supplementary 3)

The system according to supplementary 1,
wherein the processor is configured to select, on the basis of the content of the information and the emotional state, a related external service or section as the external information processing apparatus, and transmit the information together with a generated result of the response to the external service or section.

What is claimed is:

1. A system comprising:
circuitry configured to:
receive, via a communication interface coupled to a packet-switched network, natural language information from a user terminal, and perform language analysis processing including structural analysis and phrase extraction on the natural language information to generate analysis result data indicating content and intent;
acquire acoustic information from the user terminal, convert the acoustic information to character information via acoustic analysis and speech recognition processing, and supply the character information to the language analysis processing;
execute a query to an external information processing apparatus via the communication interface based on identification information extracted from the natural language information, acquire external information, and associate the external information with the analysis result data;
receive emotion analysis result data indicating an emotional state of a user, generate a prompt sentence that defines a tone and explanatory content of a response based on the analysis result data, the associated external information, and the emotion analysis result data, and input the prompt sentence to a generative neural network model to cause the generative neural network model to generate a response sentence; and
format the response sentence as display data and transmit the display data to the user terminal via the communication interface.

2. The system according to claim 1, wherein the circuitry is configured to perform the language analysis processing by tokenizing the natural language information, applying morphological analysis, syntactic parsing, and semantic role labeling, and extracting phrase units and identification information as structured analysis result data.

3. The system according to claim 2, wherein the circuitry is configured to perform the acoustic analysis by extracting acoustic feature vectors including tone, volume, speech rate, and spectral characteristics from the acoustic information, applying a trained emotion classification model to compute emotion probability scores, and generating the emotion analysis result data as an emotion label and intensity value.

4. The system according to claim 3, wherein the circuitry is configured to set priority information indicating at least one of a level of detail, an explanation order, and a response length in accordance with the emotional state based on the emotion analysis result data, and incorporate the priority information into the prompt sentence to control content and presentation order of the response sentence.

5. The system according to claim 1, wherein the circuitry is configured to determine attribute information indicating at least one of a domain classification and a routing target based on the analysis result data and the external information, and include an instruction sentence containing the attribute information as part of the prompt sentence input to the generative neural network model.

6. The system according to claim 5, wherein the circuitry is configured to route the response sentence or a routing directive to a service endpoint associated with the determined routing target based on a priority level derived from the emotion analysis result data, and store a routing record in a storage device.

7. The system according to claim 6, wherein the circuitry is configured to assign the priority level by mapping the emotion label and intensity value to a priority tier in a predefined priority table, and selecting a routing endpoint from candidates ordered by priority tier and current load metrics.

8. The system according to claim 1, wherein the circuitry is configured to integrate the external information into at least one of the prompt sentence and the response sentence by appending the external information as a context block in the prompt sentence and instructing the generative neural network model to incorporate the context block in the generated response.

9. The system according to claim 8, wherein the circuitry is configured to execute the query to the external information processing apparatus by constructing a parameterized query from the extracted identification information, receiving structured response data, and storing the structured response data in a storage device in association with the analysis result data.

10. The system according to claim 1, wherein the circuitry is configured to receive consultation content including audio information and character information, extract safety concern terms and psychological state terms via natural language processing including morphological analysis, syntactic analysis, and semantic analysis, and incorporate the extracted terms as conditions in the prompt sentence for generating a psychologically considerate response.

11. The system according to claim 10, wherein the circuitry is configured to evaluate a risk level based on the safety concern terms and the emotion analysis result data, store a risk assessment record in a storage device, and transmit a risk notification to a service endpoint when the risk level exceeds a threshold.

12. The system according to claim 10, wherein the circuitry is configured to generate conditions for coordination with an external organization in the prompt sentence when the extracted terms indicate a need for external referral, and cause the generative neural network model to generate a response that includes referral guidance.

13. The system according to claim 1, wherein the circuitry is configured to store the prompt sentence, the analysis result data, the emotion analysis result data, and the generated response sentence as consultation history in a storage device, and retrieve consultation history records based on session identifiers to provide continuity across successive interactions.

14. The system according to claim 13, wherein the circuitry is configured to incorporate relevant consultation history records as additional context in subsequently generated prompt sentences, enabling the generative neural network model to maintain coherence across a multi-turn consultation session.

15. The system according to claim 1, wherein the circuitry is configured to monitor a response latency metric of the generative neural network model, and when the response latency exceeds a threshold, transmit an intermediate acknowledgment message to the user terminal via the communication interface while the response sentence is being generated.

16. The system according to claim 1, wherein the circuitry is configured to apply machine translation to the natural language information when the user terminal transmits text in a language other than a canonical processing language, and to translate the response sentence into the language of the user terminal before formatting as display data.

17. The system according to claim 16, wherein the circuitry is configured to detect the language of the natural language information by applying a language identification algorithm to the text tokens, retrieve a translation model corresponding to the detected language, and apply the translation model to convert the natural language information to the canonical processing language.

18. A system comprising:
circuitry configured to:
receive, via a communication interface coupled to a packet-switched network, natural language information from a user terminal, perform language analysis processing including structural analysis, phrase extraction, and intent detection, and generate analysis result data;
convert acoustic information from the user terminal to character information via speech recognition processing, and analyze acoustic characteristics to generate emotion analysis result data including an emotion label and intensity value;
execute a query to an external information processing apparatus via the communication interface based on identification information extracted from the natural language information, and associate retrieved external information with the analysis result data;
set priority information based on the emotion analysis result data, generate a prompt sentence incorporating the analysis result data, the external information, the emotion analysis result data, and the priority information, and input the prompt sentence to a generative neural network model to generate a response sentence;
determine a routing target based on the analysis result data and the external information, route the response sentence to a service endpoint based on the priority information and the routing target; and
format the response sentence as display data and transmit the display data to the user terminal via the communication interface.

19. The system according to claim 18, wherein the circuitry is configured to store the prompt sentence, analysis result data, emotion analysis result data, and response sentence as consultation history in a storage device, and incorporate consultation history as additional context in subsequent prompt sentences.

20. A method comprising:
receiving, via a communication interface coupled to a packet-switched network, natural language information from a user terminal, and performing language analysis processing including structural analysis and phrase extraction on the natural language information to generate analysis result data;
acquiring acoustic information from the user terminal, converting the acoustic information to character information via acoustic analysis and speech recognition processing, and supplying the character information to the language analysis processing;
executing a query to an external information processing apparatus via the communication interface based on identification information extracted from the natural language information, acquiring external information, and associating the external information with the analysis result data;
receiving emotion analysis result data indicating an emotional state of a user, generating a prompt sentence that defines a tone and explanatory content of a response based on the analysis result data, the associated external information, and the emotion analysis result data, and inputting the prompt sentence to a generative neural network model to cause the generative neural network model to generate a response sentence; and
formatting the response sentence as display data and transmitting the display data to the user terminal via the communication interface.
